(19) United States
(12) Patent Application Publication
(10) Pub. No.: US 2013/0038683 A1
(43) Pub. Date: Feb. 14, 2013

(54) IMAGE DATA TRANSMISSION APPARATUS, IMAGE DATA TRANSMISSION METHOD, IMAGE DATA RECEIVING APPARATUS AND IMAGE DATA RECEIVING METHOD

(71) Applicant: Ikuo Tsukagoshi, Tokyo (JP)

(72) Inventor: Ikuo Tsukagoshi, Tokyo (JP)

(73) Assignee: SONY CORPORATION, Tokyo (JP)

(21) Appl. No.: 13/643,834

(22) PCT Filed: Mar. 2, 2012
(86) PCT No.: PCT/JP2012/001439

§ 371 Date: Oct. 26, 2012

(30) Foreign Application Priority Data
Mar. 4, 2011 (JP) 2011-048392
Mar. 25, 2011 (JP) 2011-068906

(51) Int. Cl. H04N 13/00

(52) U.S. Cl. 348/42; 348/E13.062; 348/E13.071

(57) ABSTRACT

Service compatibility with respect to a 2D TV is realized when transmitting frame compatible type stereoscopic image data.

When the image data is frame compatible type stereoscopic image data, image region information for cropping image data for 2D display from the image data after decoding is inserted into a compressed video stream. In the 2D television receiving device (2D TV) of the receiving side, it is possible to crop image data for 2D display from the image data after decoding and to obtain 2D image data based on the image region information.

### TECHNICAL FIELD

The present invention relates to an image data transmission apparatus, an image data transmission method, an image data receiving apparatus and an image data receiving method. In particular, the invention relates to an image data transmission apparatus or the like transmitting a compression video stream of frame compatible type stereoscopic image data.

### BACKGROUND ART

For example, in PTL 1, there is proposed a transfer system using television airwaves of stereoscopic image data. In this transfer system, stereoscopic image data including image data for the left eye and image data for the right eye is transmitted and stereoscopic image display using binocular parallax is performed in the television receiving device.

FIG. 24 shows the relationship between display positions of left and right images of an object (body) on a screen and the reproduction position of a stereoscopic image (3D image) thereof in the stereoscopic image display using binocular parallax. For example, in relation to object A displayed such that the left image La is shifted to the right side and the right image Ra is shifted to the left side as shown on the screen, since the left and right lines of sight intersect in front of the screen surface, the reproduction position of the stereoscopic image thereof is in front of the screen surface. DPa represents a parallax vector of the horizontal direction relating to object A.

Further, for example, in relation to object B displayed such that the left image Lb and the right image Rb are at the same position as shown on the screen, since the left and right lines of sight intersect at the screen surface, the reproduction position of the stereoscopic image thereof is on the screen surface. In addition, for example, in relation to object C displayed such that the left image Lc is shifted to the left side and the right image Rc is shifted to the right side as shown on the screen, since the left and right lines of sight intersect behind the screen surface, the reproduction position of the stereoscopic image thereof is behind the screen surface. DPc represents a parallax vector of the horizontal direction relating to object C.

Conventionally, as the transfer format of stereoscopic image data, frame compatible type stereoscopic image data in side-by-side format, top-and-bottom format, or the like is known. For example, FIG. 25 (a) shows the side-by-side format and FIG. 25 (b) shows the top-and-bottom format. Here, a case where the pixel format is 1920×1080 is shown.

As shown in FIG. 25 (a), the side-by-side format is a format in which pixel data of left eye image data is transferred in the front half of the horizontal direction and pixel data of right eye image data is transferred in the rear half of the horizontal direction. With this format, for the left eye image data and the right eye image data respectively, the pixel data of the horizontal direction is thinned out by half and the horizontal resolution is half that of the original signal.

As shown in FIG. 25 (b), the top-and-bottom format is a format in which data of each line of left eye image data is transferred in the front half of the vertical direction and data of each line of right eye image data is transferred in the rear half of the vertical direction. With this format, the lines of the left eye image data and the right eye image data are thinned out by half and the vertical resolution is half that of the original signal.

Here, brief description will be given of the display image data generation process at the receiving side. FIG. 26(a) schematically shows a process relating to two-dimensional image data of a pixel format of 1920×1080. In this case, at the transmission side, in order to perform encoding for each 16×16 block, 8 lines formed of blank data are added and encoding is performed as image data of 1920 pixels×1088 lines.

Therefore, at the receiving side, image data of 1920 pixels×1088 lines can be obtained after decoding. However, since the eight lines therein are blank data, cropping of the image data of 1920 pixels×1080 lines including a substantial amount of image data is performed and image data for display for a 2D television receiving device (below, appropriately referred to as a “2D TV”) is generated.

FIG. 26 (b) schematically shows a process relating to stereoscopic image data (3D image data) of side-by-side format of a pixel format of 1.920×1080. In this case also, at the transmission side, in order to perform encoding for each 16×16 block, 8 lines formed of blank data are added and encoding is performed as image data of 1920 pixels×1088 lines.

Therefore, at the receiving side, image data of 1920 pixels×1088 lines can be obtained after decoding. However, since the eight lines therein are blank data, cropping of the image data of 1920 pixels×1080 lines including a substantial amount of image data is performed. Then, the image data is divided into two parts of left and right, a horizontal direction scaling process is performed on each, and image data for display of the left eye and right eye for the stereoscopic television receiving device (below, appropriately referred to as a “3D TV”) is generated.

FIG. 26 (c) schematically shows a process relating to stereoscopic image data (3D image data) of the top-and-bottom format of the pixel format of 1920×1080. In this case also, at the transmission side, in order to perform encoding for each 16×16 block, 8 lines formed of blank data are added and encoding is performed as image data of 1920 pixels×1088 lines.

Therefore, at the receiving side, image data of 1920 pixels×1088 lines can be obtained after decoding. However, since the eight lines therein are blank data, cropping of the image data of 1920 pixels×1080 lines including a substantial amount of image data is performed. Then, the image data is divided into two parts of top and bottom, a vertical direction scaling process is performed on each, and image data for display of the left eve and right eye for the 3D TV is generated.

### CITATION LIST

### Patent Literature

PTL 1: Japanese Unexamined Patent Application Publication No. 2005-6114

### SUMMARY OF INVENTION

### Technical Problem

In a 2D TV, when stereoscopic image data of the side-by-side format or the top-and-bottom format is received, if the above-described image data of 1920 pixels×1080 lines is cropped and image data for display for a 2D TV is generated, similar images are lined up on the left and right or at the top and bottom and an unnatural image display is formed as shown in FIG. 27 (a) and FIG. 27 (b).

The present invention realizes service compatibility with respect to a 2D TV when transmitting frame compatible type stereoscopic image data. In addition, the present invention facilitates the process of cropping data in the 3D TV when transmitting frame compatible type stereoscopic image data.

### Solution to Problem

The present invention provides an imagedata transmission apparatus including: an encoding unit performing an encoding process with respect to image data and generating a compressed video stream; and a transmission unit transmitting the compressed video stream generated in the encoding unit, in which the encoding unit inserts image region information for cropping image data for 2D display from the image data after decoding into the compressed video stream when the image data is frame compatible type stereoscopic image data.

In the invention, the encoding unit performs an encoding process with respect to the image data and generates a compressed video stream. Then, the compressed video stream is transmitted by the transmission unit. In the encoding unit, image region information for cropping image data for 2D display from the image data after decoding is inserted into the compressed video stream when the image data is frame compatible type stereoscopic image data. Here, the frame compatible type stereoscopic image data is, for example, stereoscopic image data of the side-by-side format, or the top-and-bottom format.

In the present invention, for example, the image region information is set as information showing the size of the region and information showing the position of the region, or information showing the size of the region. In this case, for example, the compressed video stream is an MPEG2 video format compressed video stream, the information showing the size of the region is included as an extension parameter in the Sequence Display Extension, and the information showing the position of the region is included as an extension parameter in the Picture Display Extension.

In the present invention, image region information for cropping image data for 2D display from the image data after decoding is inserted into the compressed video stream when the image data is frame compatible type stereoscopic image data. Therefore, in the 2D television receiving device (2D TV) of the receiving side, it is possible to crop image data for 2D display from the image data after decoding and to obtain 2D image data based on the image region information. Therefore, it is possible to realize service compatibility with respect to a 2D TV when transmitting frame compatible type stereoscopic image data.

In addition, in the stereoscopic television receiving device (3D TV) of the receiving side, it is possible to crop image data for 2D display from the image data after decoding and to obtain 2D image data based on the image region information when a 2D display mode is selected by an operation of the user. Therefore, it is possible to realize service compatibility with respect to a 3D TV (2D display mode) when transmitting frame compatible type stereoscopic image data.

Here, in the present invention, for example, the encoding unit may be set so as to further insert image region information for cropping image data for stereoscopic display from the image data after decoding into the compressed video stream when the image data is frame compatible type stereoscopic image data. In this manner, it is possible to facilitate the process of cropping data in the stereoscopic television receiving device (3D TV) of the receiving side. In other words, in the 3D TV of the receiving side, when a stereoscopic display mode is selected by the operation of a user, it is possible to easily and correctly perform cropping of the image data for stereoscopic display from the image data after decoding based on the image region information, whereby it is possible to favorably obtain left eye image data and right eye image data.

In addition, the present invention also provides an image data receiving apparatus including: a receiving unit receiving a compressed video stream generated by performing an encoding process with respect to image data; a decoding unit performing a decoding process with respect to the compressed video stream received in the receiving unit and generating image data; and an image data processing unit obtaining image data for display based on the image data generated in the decoding unit, in which image region information for cropping image data for 2D display from the image data after decoding is inserted into the compressed video stream when the image data is frame compatible type stereoscopic image data, and the image data processing unit uses the image region information inserted into the compressed video stream from the stereoscopic image data, crops image data for 2D display, and obtains 2D image data when the image data generated in the decoding unit is frame compatible type stereoscopic image data.

In the present invention, the receiving unit performs an encoding process with respect to image data and receives a generated compressed video stream. Then, the decoding unit performs a decoding process with respect to the compressed video stream and generates image data. Then, the image data processing unit enables the obtaining of image data for display based on the image data. In this case, for example, the compressed video stream is an MPEG2 video format compressed video stream.

Here, image region information for cropping image data for 2D display from the image data after decoding is inserted into the compressed video stream when the image data is frame compatible type stereoscopic image data. Here, the frame compatible type stereoscopic image data is, for example, stereoscopic image data of side-by-side format or top-and-bottom format.

In the image data processing unit, when the image data generated in the decoding unit, that is, the image data after decoding, is frame compatible type stereoscopic image data, it is possible to use the image region information to crop image data for 2D display from the stereoscopic image data and obtain 2D image data.

In the present invention, in the image data processing unit, when the image data after decoding is frame compatible type stereoscopic image data, the cropping of the image data for 2D display from the stereoscopic image data is automatically performed using the image region information inserted in the compressed video stream. Therefore, in a 2D television receiving device (2D TV), when frame compatible type stereoscopic image data is to be transmitted, it is possible to automatically display a favorable 2D image without performing unnatural image display in which similar images are lined up on the left and right or at the top and bottom.

In addition, in the present invention, for example, setting may be made such that a user operation unit by which a user selects a 2D display mode or a stereoscopic display mode is further provided, and, in a case where the 2D display mode is selected by the user operation unit when the image data generated in the decoding unit is frame compatible type stereoscopic image data, the image data processing unit crops image data for 2D display from the stereoscopic image data using the image region information inserted into the compressed video stream, and obtains 2D image data.

In this case, in a case where the 2D display mode is selected when the image data after decoding is frame compatible type stereoscopic image data, the cropping of the image data for 2D display from the stereoscopic image data thereof is automatically performed using the image region information inserted into the compressed video stream. Therefore, in the stereoscopic television receiving device (3D TV), when frame compatible type stereoscopic image data is to be transmitted, in a case where the 2D display mode is selected, it is possible to automatically display a favorable 2D image without performing unnatural image display in which similar images are lined up on the left and right or at the top and bottom.

In addition, in the present invention, for example, setting may be made such that a user operation unit by which a user selects a 2D display mode or a stereoscopic display mode is further provided, and, in a case where the stereoscopic display mode is selected by the user operation unit when the image data generated in the decoding unit is frame compatible type stereoscopic image data, the image data processing unit takes a value double that of the half resolution value shown in the image region information inserted in the compressed video stream, and obtains full resolution left eye image data and right eye image data from the stereoscopic image data. In this case, it is possible to perform favorable stereoscopic image display using the image region information inserted in the compressed video stream.

In addition, the present invention provides an image data transmission apparatus including: an encoding unit performing an encoding process with respect to image data and generating a compressed video stream; and a transmission unit transmitting the compressed video stream generated in the encoding unit, in which the encoding unit inserts image region information for cropping image data for stereoscopic display from the image data after decoding into the compressed video stream when the image data is frame compatible type stereoscopic image data.

In the present invention, the encoding unit performs an encoding process with respect to the image data and generates a compressed video stream. Then, the compressed video stream is transmitted by the transmission unit. In the encoding unit, image region information for cropping image data for stereoscopic display from the image data after decoding is inserted into the compressed video stream when the image data is frame compatible type stereoscopic image data. Here, the frame compatible type stereoscopic image data is, for example, stereoscopic image data of side-by-side format or top-and-bottom format.

In the present invention, for example, the compressed video stream is an MPEG2 video format compressed video stream and the image region information is inserted into the user data region of the picture layer. In addition, in the present invention, for example, signaling information enabling the identification of frame compatible type stereoscopic image data is inserted into the user data region of the picture layer, and the image region information is inserted into a position after the signaling information.

In the present invention, image region information for cropping image data for stereoscopic display from the image data after decoding is inserted into the compressed video stream when the image data is frame compatible type stereoscopic image data. Therefore, it is possible to facilitate the process of cropping data in the stereoscopic television receiving device (3D TV) of the receiving side. In other words, in the 3D TV of the receiving side, when a stereoscopic display mode is selected by the operation of a user, it is possible to easily and correctly perform cropping of the image data for stereoscopic display from the image data after decoding based on the image region information, whereby it is possible to favorably obtain left eye image data and right eye image data.

In addition, the present invention also provides an image data receiving apparatus including: a receiving unit receiving a compressed video stream generated by performing an encoding process with respect to image data, a decoding unit performing a decoding process with respect to the compressed video stream received in the receiving unit and generating image data; and an image data processing unit obtaining image data for display based on the image data generated in the decoding unit, in which image region information for cropping image data for stereoscopic display from the image data after decoding is inserted into the compressed video stream when the image data is frame compatible type stereoscopic image data, and the image data processing unit uses the image region information inserted into the compressed video stream from the stereoscopic image data, crops image data for stereoscopic display, and obtains left eye image data and right eye image data when the image data generated in the decoding unit is frame compatible type stereoscopic image data.

In the present invention, the receiving unit performs an encoding process with respect to image data and receives a generated compressed video stream. Then, the decoding unit performs a decoding process with respect to the compressed video stream and generates image data. Then, the image data processing unit enables the obtaining of image data for display based on the image data. In this case, for example, the compressed video stream is an MPEG2 video format compressed video stream.

Here, image region information for cropping image data for stereoscopic display from the image data after decoding is inserted into the compressed video stream when the image data is frame compatible type stereoscopic image data. Here, the frame compatible type stereoscopic image data is, for example, stereoscopic image data of side-by-side format or top-and-bottom format.

In the image data processing unit, when the image data generated in the decoding unit, that is, the image data after decoding, is frame compatible type stereoscopic image data, it is possible to use the image region information to crop image data for stereoscopic display from the stereoscopic image data and obtain left eye image data and right eye image data.

In the present invention, in the image data processing unit, when the image data after decoding is frame compatible type stereoscopic image data, the cropping of the image data for stereoscopic display from the stereoscopic image data is automatically performed using the image region information inserted in the compressed video stream. Therefore, in a stereoscopic television receiving device (3D TV), when frame compatible type stereoscopic image data is to be transmitted, in a case where a stereoscopic display mode is selected by the operation of a user, it is possible to easily and correctly perform cropping of the image data for stereoscopic display from the image data after decoding, whereby it is possible to favorably obtain left eye image data and right eye image data.

### Advantageous Effects of Invention

According to the present invention, it is possible to realize service compatibility with respect to a 2D TV when transmitting frame compatible type stereoscopic image data. In addition, according to the present invention, it is possible to facilitate the process of cropping data in the 3D TV when transmitting frame compatible type stereoscopic image data.

### BRIEF DESCRIPTION OF DRAWINGS

FIG. 1 is a block diagram of a configuration example of an image transceiver system as an embodiment of the present invention.

FIG. 2 is a block diagram of a configuration example of a transmission data generation unit of a broadcast station configuring the image transceiver system.

FIG. 3 is a diagram of the data structure (Syntax) of user data including signal information (Stereo_Video_Format_Signaling).

FIG. 4 is a diagram of the data structure (Syntax) of signaling information (Stereo_Video_Format_Signaling ( )).

FIG. 5 is a diagram of main data regulation contents (Semantics) in the data structure of the signaling information.

FIG. 6 is a diagram of “Stereo_Video_Format_Signaling_type”3D image format identification information.

FIG. 7 is a diagram of an SDE structure example (Syntax) regulated by MPEG2 video.

FIG. 8 is a diagram of a PDE structure example (Syntax) regulated by MPEG2 video.

FIG. 9 is a diagram of an example of setting extension parameters inside SDE and PDE as image region information showing a cropped region.

FIG. 10 is a diagram of an example of setting extension parameters inside SDE and PDE as image region information showing a cropped region.

FIG. 11 is a diagram of the data structure (Syntax) of user data including stereoscopic image region information (Stereo_Video_Cropping).

FIG. 12 is a diagram of the data structure (Syntax) of stereoscopic image region information (Stereo_Video_Cropping).

FIG. 13 is a diagram of main data regulation contents (Semantics) in the data structure of the stereoscopic image region information.

FIG. 14 is a schematic diagram of the positional relationship of signaling information and stereoscopic image region information inserted in the user data region of the picture layer of the compressed video stream.

FIG. 15 is a block diagram of a configuration example of a 2D television receiving device (2D TV) as a receiving device configuring the image transceiver system.

FIG. 16 is a flowchart of an example of the order of a stream identification process in the CPU.

FIG. 17 is a block diagram of a configuration example of a stereoscopic television receiving device (3D TV) as a receiving device configuring the image transceiver system.

FIG. 18 is a flowchart of the order of a control process relating to the process switching of the image data processing unit in the CPU.

FIG. 19 is a diagram for describing a process in the stereoscopic display mode in the image data processing unit of the stereoscopic television receiving device.

FIG. 20 is a diagram for describing a process in the stereoscopic display mode in the image data processing unit of the stereoscopic television receiving device.

FIG. 21 is a diagram of an example of setting extension parameters inside SDE as image region information showing a cropped region.

FIG. 22 is a diagram of an example of setting extension parameters inside SDE as image region information showing a cropped region.

FIG. 23 is a diagram bringing together the display processes relating to 2D streams and 3D streams in the 2D television receiving device (2DTV) and the stereoscopic television receiving device (3D TV).

FIG. 24 is a diagram for describing the relationship of the display position of the left and right images of the object on the screen and the reproduction position of the stereoscopic image thereof in the stereoscopic image display using binocular parallax.

FIG. 25 is a diagram of an example of the transfer format of frame compatible type stereoscopic image data (side-by-side format and top-and-bottom format).

FIG. 26 is a diagram for describing a display image data generation process at the receiving side (2D TV, 3D TV).

FIG. 27 is a diagram of an unnatural image display when stereoscopic image data of the side-by-side format or the top-and-bottom format is received in the 2D TV.

### DESCRIPTION OF EMBODIMENTS

Hereafter, description will be given of embodiments for realizing the invention (below, “embodiments”). Further, the description will be given in the following order.

1. Embodiments

2. Modifications

### 1. Embodiments

“Image Transceiver System”

FIG. 1 shows a configuration example of an image transceiver system 10 as an embodiment. The image transceiver system 10 is configured by a broadcast station 100 and a receiving device 200. The broadcasting station 100 attaches a transport stream (multiplexed data stream data) TS having a compressed video stream including 2D image data or stereoscopic imagedata to a broadcast wave and performs transmission thereof.

In this embodiment, the compressed video stream is an MPEG2 video format compressed video stream. In addition, in the embodiment, image region information for cropping image data for 2D display from the image data after decoding is inserted into the compressed video stream including frame compatible type stereoscopic image data. Further, in the embodiment, image region information for cropping image data for stereoscopic display from the image data after decoding is inserted into the compressed video stream. The frame compatible type stereoscopic image data is, for example, stereoscopic image data of the side-by-side format, the top-and-bottom format, or the like.

In addition, in the embodiment, the pixel format of the stereoscopic image data is set to 1920×1080. The broadcasting station 100 performs encoding for each 16×16 block with respect to the stereoscopic image data. There fore, the broadcasting station 100 adds 8 lines formed of blank data and performs encoding as image data of 1920 pixels×1088 lines.

The receiving device 200 receives the transport stream TS attached to the broadcast wave and sent from the broadcasting station 100. The receiving device 200 obtains the compressed video stream from the received transport stream TS. In this case, image region information for cropping image data for 2D display from the image data after decoding is inserted into the compressed video stream including the frame compatible type stereoscopic image data. In addition, image region information for cropping image data for stereoscopic display from the image data after decoding is inserted into the compressed video stream.

The receiving device 200 performs a decoding process with respect to the compressed video stream and generates 2D image data or stereoscopic image data. Then, when the receiving device 200 is a 2D TV, in a case where the image data after decoding is 2D image data, the receiving device 200 performs a 2D display process which is the same as conventionally performed and displays a 2D image.

In addition, when the receiving device 200 is a 2D TV, in a case where the image data after deco ding is stereoscopic image data, the receiving device 200 uses image region information for cropping image data for 2D display inserted in the compressed video stream. That is, the receiving device 200 crops image data for 2D display from the stereoscopic image data using the image region information, obtains 2D image data by performing a horizontal or a vertical scaling process, and performs a 2D image display.

In addition, when the receiving device 200 is a 3D TV, in a case where the image data after decoding is 2D image data, the receiving device 200 performs a 2D display process which is the same as that conventionally performed and displays a 2D image. In addition, when the receiving device 200 is a 3D TV, in a case where the image data after decoding is frame compatible type stereoscopic image data and the 2D display mode is selected, the receiving device 200 uses image region information for cropping image data for 2D display inserted in the compressed video stream. That is, the receiving device 200 crops image data for 2D display from the stereoscopic image data using the image region information, obtains 2D image data by performing a horizontal or a vertical scaling process, and performs a 2D image display.

In addition, when the receiving device 200 is a 3D TV, in a case where the image data after decoding is frame compatible type stereoscopic image data and the stereoscopic display mode is selected, the receiving device 200 performs stereoscopic image display based on the stereoscopic image data. In this case, the receiving device 200 uses image region information for cropping image data for stereoscopic display inserted in the compressed video stream. That is, the receiving device 200 crops image data for stereoscopic display from the stereoscopic image data using the image region information. Then, the receiving device divides the cropped image data into left and right or top and bottom, performs a scaling process in the horizontal direction or the vertical direction on each, and obtains left eye image data and right eye image data for displaying a stereoscopic image.

In this case, the receiving device 200 may use the image region information for cropping the image data for 2D display inserted into the compressed video stream. In other words, the receiving device 200 takes a value double that of the half resolution value shown in the image region information, and crops image data for stereoscopic display from the stereoscopic image data. Then, the receiving device 200 divides the cropped image data into two parts of left and right or top and bottom, performs a horizontal direction or vertical direction scaling process on each, and obtains left eye image data and right eye image data for displaying a stereoscopic image.

“Configuration Example of Transmission Data Generation Unit”

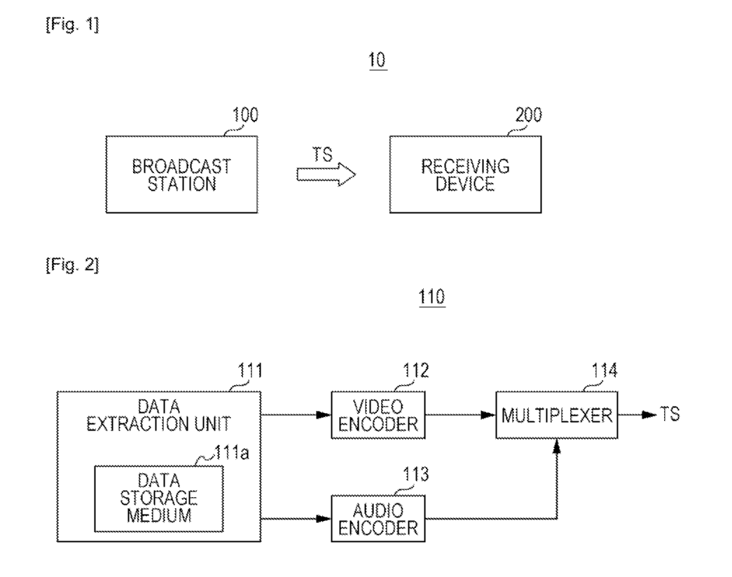

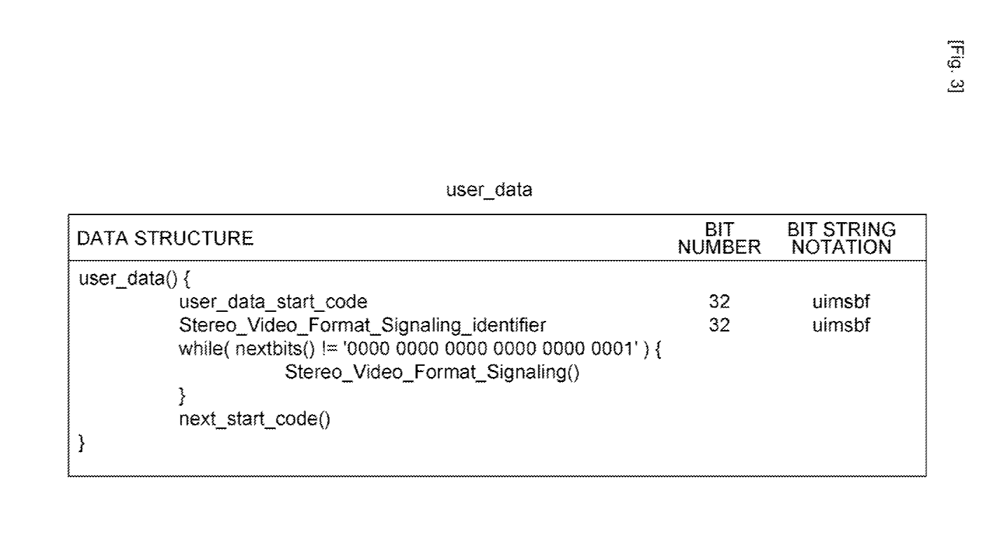

FIG. 2 shows a configuration example of a transmission data generation unit 110 generating the above-described transport stream TS in the broadcast station 100. The transmission data generation unit 110 includes a data extraction unit (archive unit) 111, a video encoder 112, an audio encoder 113, and a multiplexer 114.

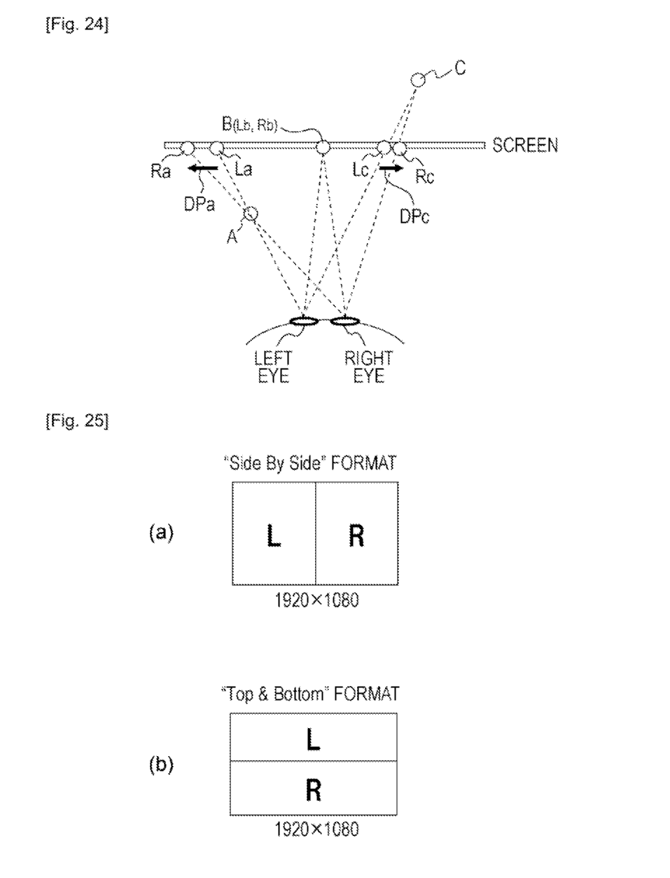

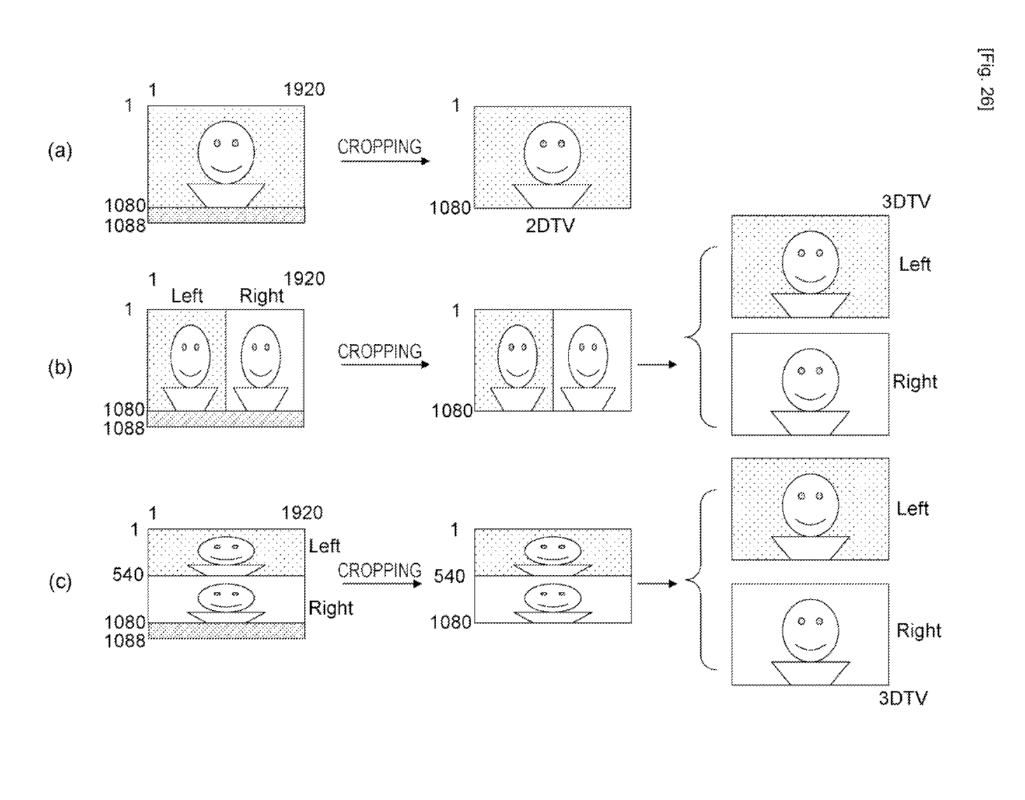

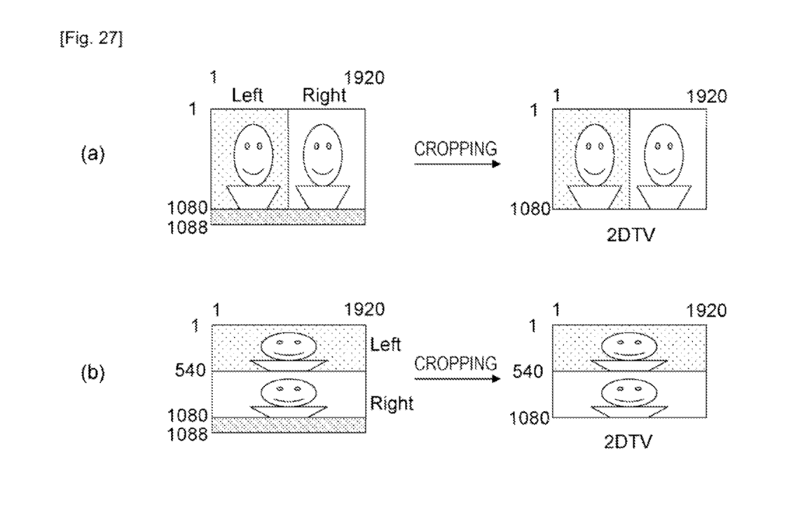

In the data extraction unit 111, a data recording medium 111a is, for example, detachably mounted. The data recording medium 111a is a disk-shaped recording medium, a semiconductor memory, or the like. On this data recording medium 111a, 2D image data or stereoscopic (3D) image data of a predetermined. TV program transmitted by the transport stream TS, is recorded. In addition, audio data corresponding to the image data is recorded on the recording medium in 111a. The stereoscopic image data includes the above-described frame compatible type stereoscopic image data, for example, stereoscopic image data in the side-by-side format, the top-and-bottom format, or the like (refer to FIG. 25(a) and (b)).

The video encoder 112 performs an encoding process in MPEG2 video format with respect to the image data output from the data extraction unit 111a, and generates a compressed video stream. In this case, in order to perform the encoding for each 16 by 16 block with respect to the image data of 1920 pixels×1080 lines, the video encoder 112 adds 8 lines formed of blank data and performs encoding as image data of 1920 pixels×1088 lines.

The video encoder 112 inserts signaling information of image data at a location corresponding to the picture layer of the compressed video stream, for example, the user data region or the picture header. This signaling information shows whether the image data is stereoscopic image data or 2D image data, and, when the image data is stereoscopic image data, shows what the transfer format is.

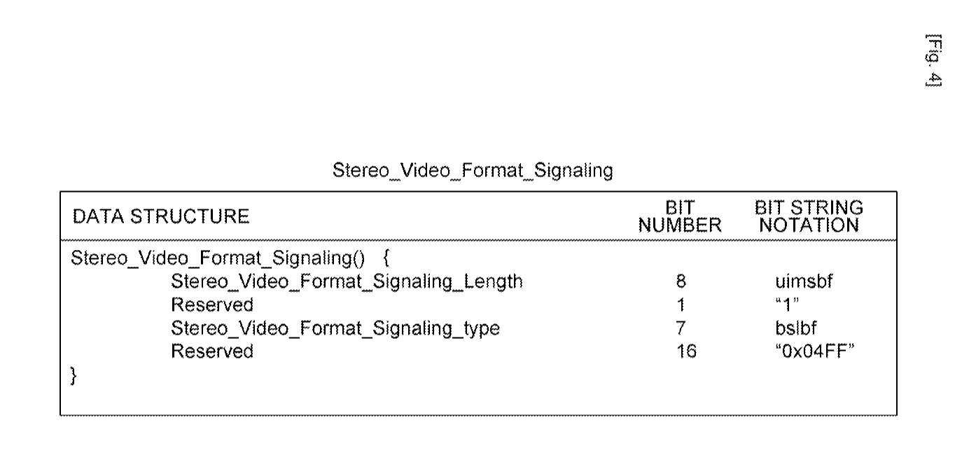

FIG. 3 shows the data structure (Syntax) of user data including signaling information (Stereo_Video_Format_Signaling). The 32-bit field of the “user_data_start_code” is a start code of user data (user_data), and is set as a fixed value of “0x000001B2”. The 32-bit field following the start code is an identifier that identifies the contents of the user data. Here, the“Stereo_Video_Format_Signaling_identifier” is set, and the signaling information (Stereo_Video_Format_Signaling) of the user data is identified. The “Stereo_Video_Format_Signaling_identifier” is set as a fixed value of “0x4A503344”. As the body of data after this identifier, signaling information (Stereo_Video_Format_Signaling ( )) is arranged.

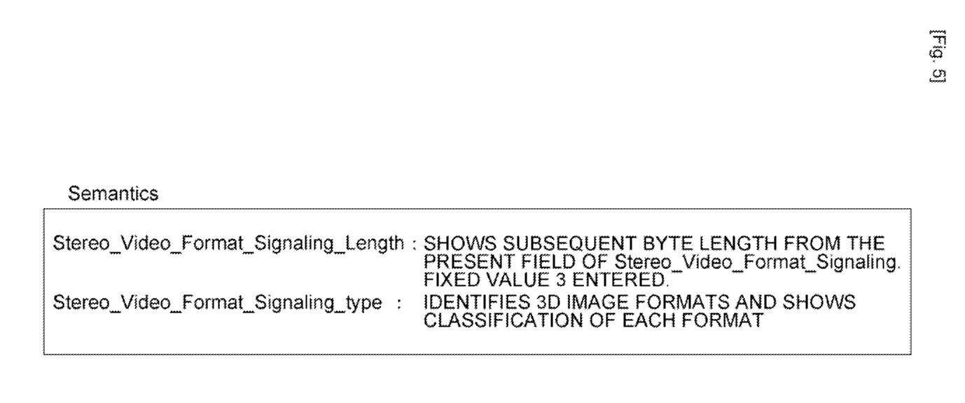

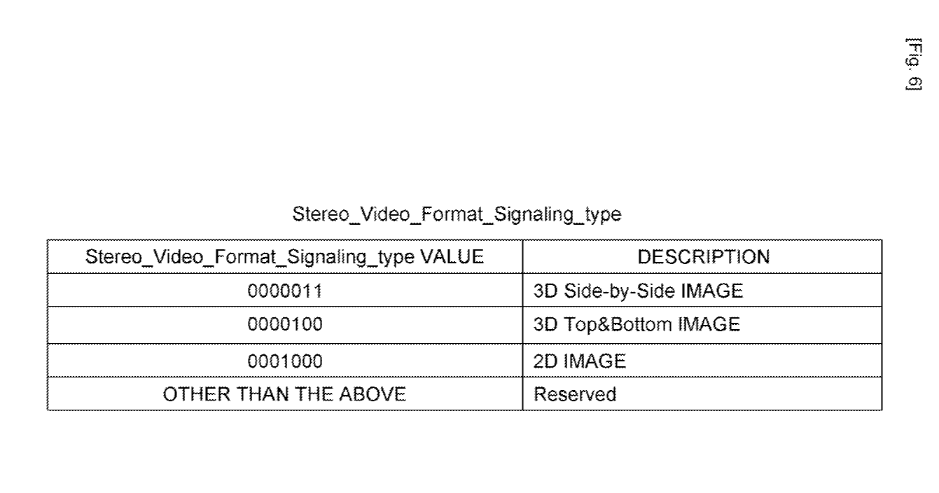

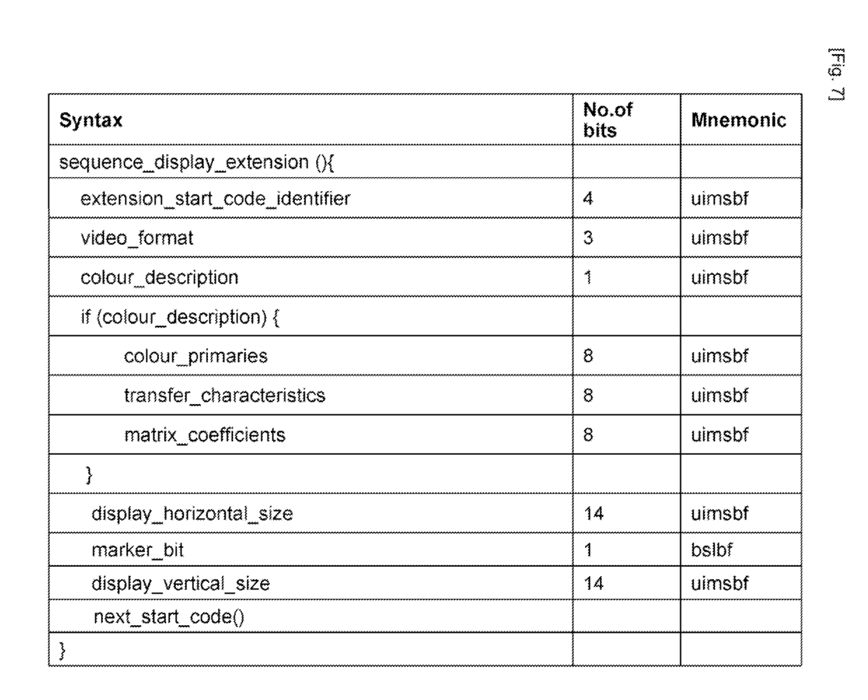

FIG. 4 shows the data structure (Syntax) of signaling information (Stereo_Video_Format_Signaling ( )) and FIG. 5 shows main data regulation contents (Semantics) thereof. The 8-bit field of “Stereo_Video_Format_Signaling_Length” shows the subsequent byte length. Here, this is set to a fixed value of “3”. The 7-bit field of “Stereo_Video_Format_Signaling_type” is information that identifies the 3D image format, and shows the type of each format. As shown in FIG. 6, “0000011” shows that the format is a 3D image of side-by-side format, “0000110” shows that the format is a 3D image of top-and-bottom format, and “0001000” shows that the format is a 2D image.

Returning to FIG. 2, the video encoder 112 inserts image region information (below, appropriately referred to as “2D image region information”) for cropping image data for 2D display from image data after decoding into the compressed video stream (MPEG2 video stream). The video encoder 112 inserts the 2D image region information in a case of side-by-side format or top-and-bottom format frame compatible type stereoscopic image data.

In this embodiment, the video encoder 112 uses SDE (Sequence Display Extension) and PDE (Picture Display Extension present in the system layer of the MPEG2 video stream in order to insert 2D image region information. In this embodiment, the 2D image region information is formed of information showing the size of the cropped region and information showing the position of the cropped region. The video encoder 112 includes the information showing the size of the cropped region in the SDE as an extension parameter. In addition, the video encoder 112 includes the information showing the position of the cropped region in the PDE as an extension parameter.

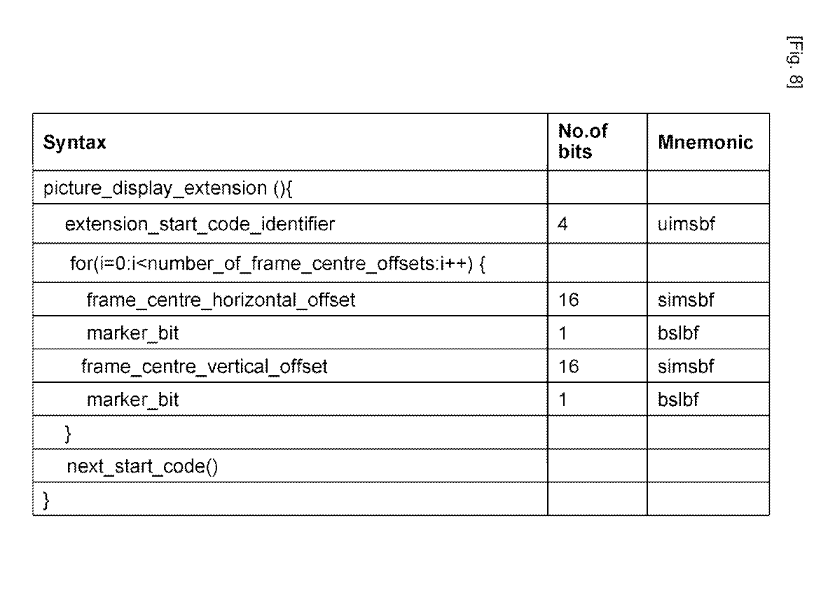

Although detailed description is omitted, FIG. 7 shows a structure example (Syntax) of SDE regulated by MPEG2 video. The video encoder 112 sets pixel number information showing the horizontal direction size of the cropped region in the 14-bit field of “display_horizontal_size” of the SDE. In addition, the video encoder 112 sets pixel number information showing the vertical direction size of the cropped region in the 14-bit field of “display_vertical_size” of the SDE.

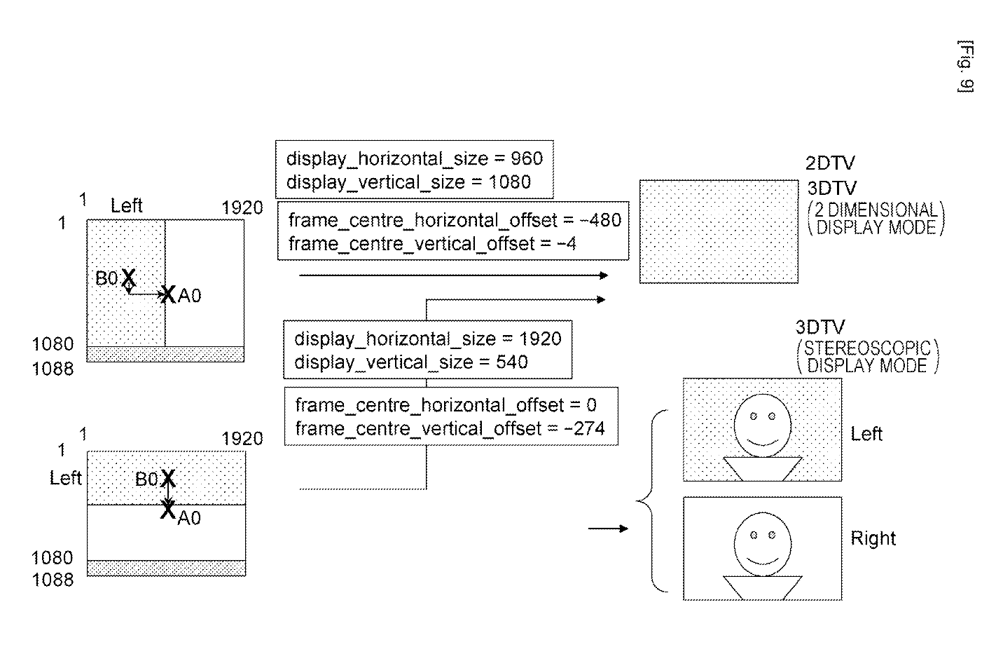

Although detailed description is omitted, FIG. 8 shows a structure example (Syntax) of PDE regulated by MPEG2 video. The video encoder 112 sets pixel number information showing the offset value of the horizontal direction of the center position of the cropped region from the center position of the image data after decoding in the 16-bit field of “frame_centre_horizontal_offset” of the PDE. In addition, the video encoder 112 sets pixel number information showing the offset value of the vertical direction of the center position of the cropped region from the center position of the image data after decoding in the 16-bit field of “frame_centre_vertical_offset” of the PDE.

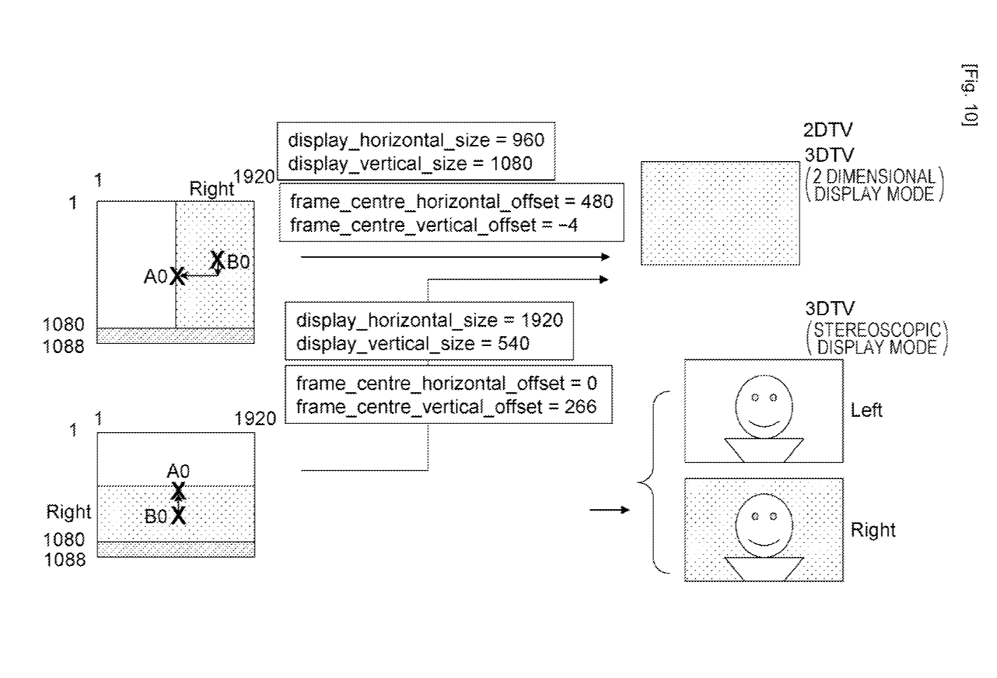

FIG. 9 shows an example of settings of each value. This example is of a case where the image data after decoding is 1920 pixels×1088 lines and image data is substantially present in 1920 pixels×1080 lines in such image data. In addition, this example is of a case where, in the receiving side, left eye image data present on the left side in the side-by-side format and left eye image data present on the upper side in the top-and-bottom format is cropped as image data for 2D display. In addition, the center position of the image data after decoding is set as A0, and the center position of the cropped region is set as B0.

In the side-by-side format, the extension parameters in SDE and in PDE are set as follows. In other words, the extension parameters are set to “display_horizontal_size=960”, and“display_vertical_size=1080”. In addition, the extension parameters are set to “frame_centre_horizontal_offset=−480”, and“frame_centre_vertical_offset=−4”. Meanwhile, in the top-and-bottom format, the extension parameters in SDE and in PDE are set as follows. In other words, the extension parameters are set to “display_horizontal_size=1920”, and “display_vertical_size=540”. In addition, the extension parameters are set to“frame_centre_horizontal_offset=0”, and“frame_centre_vertical_offset=−274”.

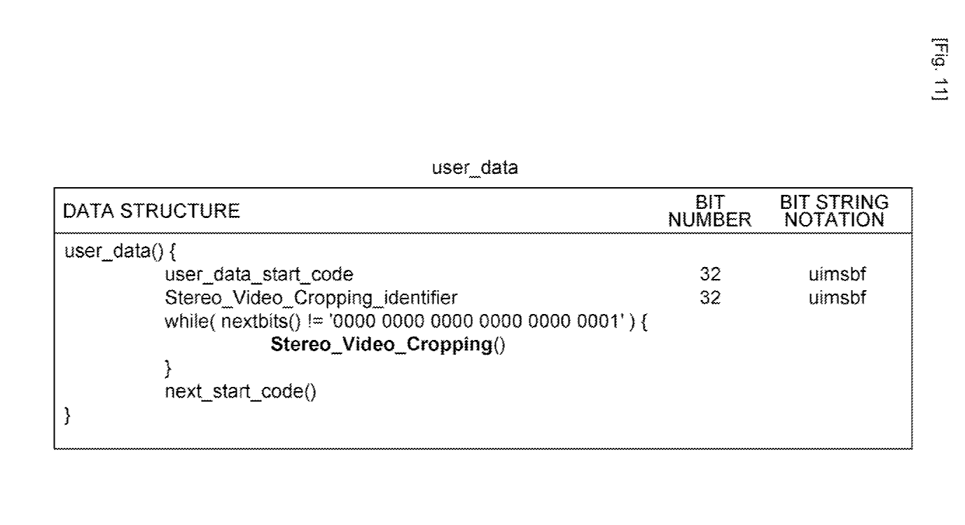

FIG. 10 shows an example of settings of each value. This example is of a case where the image data after decoding is 1920 pixels×1088 lines and image data is substantially present in 1920 pixels×1080 lines in such image data. In addition, this example is of a case where, in the receiving side, right eye image data present on the right side in the side-by-side format and right eye image data present on the bottom side in the top-and-bottom format is cut out as image data for 2D display. In addition, the center position of the image data after decoding is set as A0, and the center position of the cropped region is set as B0.

In the side-by-side format, the extension parameters in SDE and in PDE are set as follows. In other words, the extension parameters are set to “display_horizontal_size=960”, and“display_vertical_size=1080”. In addition, the extension parameters are set to “frame_centre_horizontal_offset=−480”, and“frame_centre_vertical_offset=−4”. Meanwhile, in the top-and-bottom format, the extension parameters in SDE and in PDE are set as follows. In other words, the extension parameters are set to“display_horizontal_size=1920”, and “display_vertical_size=540”. In addition, the extension parameters are set to“frame_centre_horizontal_offset=0”, and “frame_centre_vertical_offset=−266”.

Returning to FIG. 2, additionally, the video encoder 112 inserts image region information (below, appropriately referred to as “stereoscopic image region information”) for cropping image data for stereoscopic display from image data after decoding into the compressed video stream (MPEG2 video stream). The video encoder 112 inserts the stereoscopic image region information in a case of side-by-side format or top-and-bottom format frame compatible type stereoscopic image data. The video encoder 112 inserts the stereoscopic image region information at a location corresponding to the picture layer of the compressed video stream, for example, the user data region or the picture header.

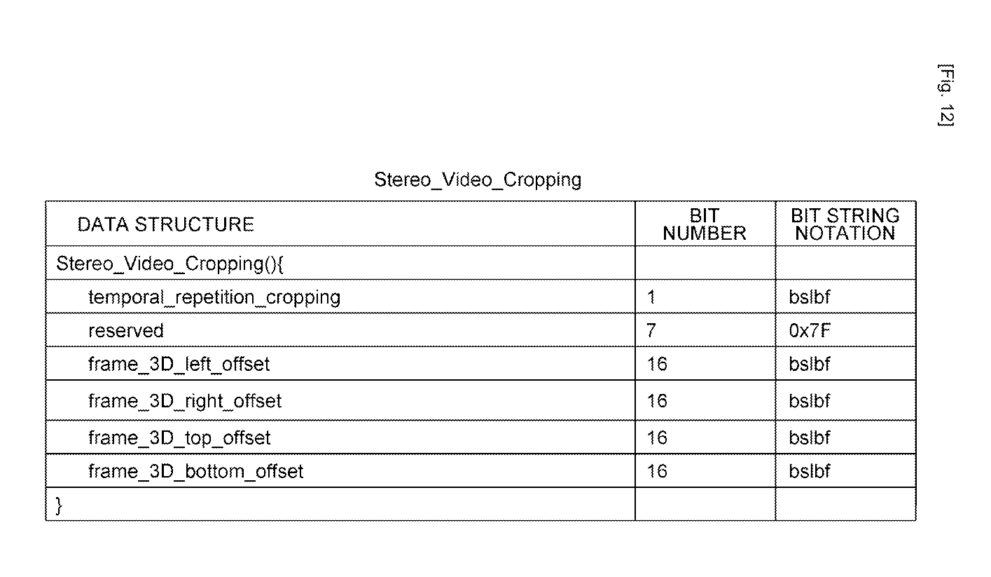

FIG. 11 shows the data structure (Syntax) of user data including stereoscopic image region information (Stereo_Video_Cropping). The 32-bit field of the “user_data_start_code” is a start code of user data (user_data), and is set as a fixed value of “0x0000001B2”. The 32-bit field following the start code is an identifier that identifies the contents of the user data. Here, the“Stereo_Video_Cropping_identifier” is set, and the fact that the user data is stereoscopic image region information (Stereo_Video_Cropping) is identified. As the body of data after this identifier, stereoscopic image region information (Stereo_Video_Cropping) is arranged.

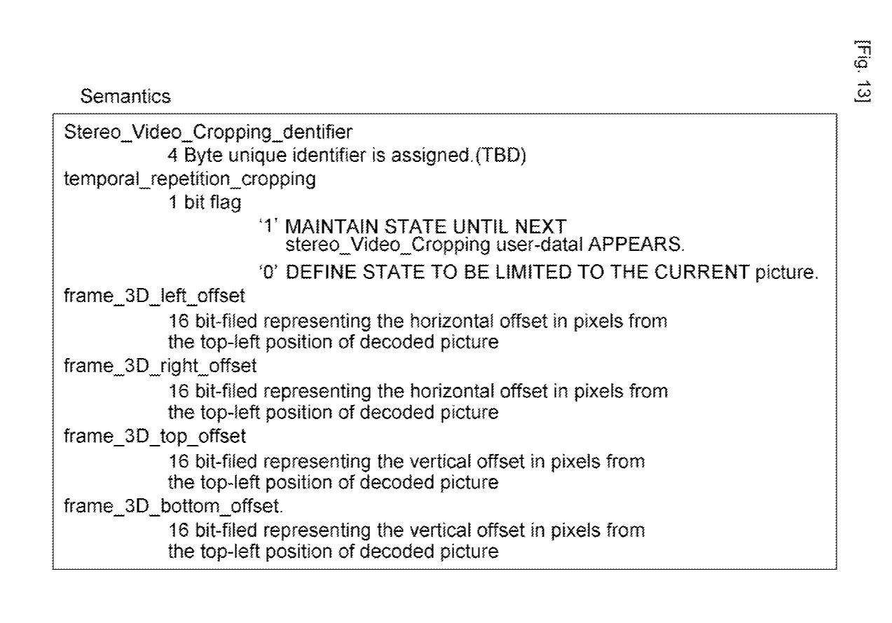

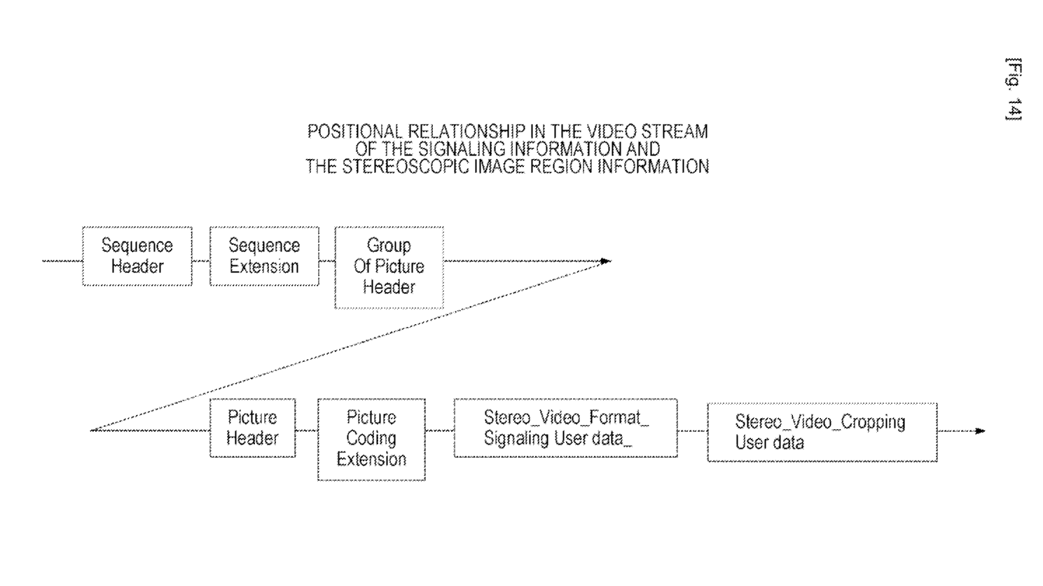

FIG. 12 shows the data structure (Syntax) of stereoscopic image region information (Stereo_Video_Cropping) and FIG. 13 shows main data regulation contents (Semantics) in the data structure thereof. “Temporal_repetition_cropping” is 1-bit flag information. Flag “1” shows that the state defined here is to be held until user data of subsequent stereoscopic image region information (Stereo_Video_Cropping) appears. Flag “0” shows that the state is defined to be limited to the current picture.

The 16-bit field of frame_{—}3D_left_offset shows the offset value of the horizontal direction of the left edge position of the stereoscopic image region from the upper left position of the image data after decoding. The 16-bit field of “frame_{—}3D_right_offset” shows the offset value of the horizontal direction of the right edge position of the stereoscopic image region from the upper left position of the image data after decoding. The 16-bit field of “frame_{—}3D_top_offset” shows the offset value of the vertical direction of the upper edge position of the stereoscopic image region from the upper left position of the image data after decoding. Further, the 16-bit field of “frame_{—}3D_bottom_offset” shows the offset value of the vertical direction of the lower edge position of the stereoscopic image region from the upper left position of the image data after decoding.

As described above, the user data including signaling information (Stereo_Video_Format_Signaling) and the user data including stereoscopic image region information (Stereo_Video_Cropping) is inserted into the user data region of the picture layer of the compressed video stream. FIG. 14 schematically shows the positional relationship of signaling information and stereoscopic image region information in such a case, and the stereoscopic image region information is inserted into a position after the signaling information.

Returning to FIG. 2, the audio encoder 113 performs encoding such as MPEG-2 Audio AAC with respect to audio data output from the data extraction unit 111 and generates a compressed audio stream. The multiplexer 114 packetizes and multiplexes each stream generated by the video encoder 112 and the audio encoder 113, and generates a transport stream (multiplexed data stream) TS.

A brief description will be given of the operation of the transmission data generation unit 110 shown in FIG. 2. 2D image data or stereoscopic (3D) image data output from the data extraction unit 111 is supplied to the video encoder 112. In this video encoder 112, with respect to such image data, an MPEG2 video format encoding process is performed, and a compressed video stream is generated.

In addition, in the video encoder 112, 2D image data or stereoscopic image data, and, in the case of stereoscopic image data, signaling information enabling identification of the transfer format is inserted at a location corresponding to the picture layer of the compressed video stream, for example, the user data region or the picture header (refer to FIGS. 3 to 6).

In addition, in the video encoder 112, when the image data is stereoscopic image data other than of the frame compatible format, 2D image region information for cropping the image data for 2D display from the image data after decoding is inserted into the compressed video stream. In this case, the image region information insertion is performed using the SDE and PDE present in the system layer of the MPEG2 video stream (refer to FIGS. 7 to 10).

In addition, in the video encoder 112, when the image data is stereoscopic image data other than of the frame compatible format, stereoscopic image region information for cropping the image data for stereoscopic display from the image data after decoding is inserted into the compressed video stream (refer to FIGS. 11 to 14). Such stereoscopic image region information is inserted at a location corresponding to the picture layer, for example, the user data region or the picture header in the same manner as the above-described signaling information.

Further, when the stereoscopic image data is output as described above from the data extraction unit 111, audio data corresponding to the stereoscopic image data is also output from the data extraction unit 111. Such audio data is supplied to the audio encoder 113. In this audio encoder 113, encoding such as MPEG-2 Audio AAC is performed with respect to audio data output and a compressed audio stream is generated.

The compressed video stream generated by the video encoder 112 is supplied to the multiplexer 114. In addition, the compressed audio stream generated by the audio encoder 113 is supplied to the multiplexer 114. In the multiplexer 114, the streams supplied from each encoder are packetized and multiplexed, and a transport stream (multiplexed data stream) TS is generated.

As described above, in the transmission data generation unit 110 shown in FIG. 2, an MPEG2 video format encoding process is performed by the video encoder 112, and a compressed video stream is generated with respect to the image data. Then, at this point, when the image data is frame compatible type stereoscopic image data, 2D image region information for cropping the image data for 2D display from the image data after decoding is inserted.

Therefore, in the 2D television receiving device of the receiving side (2D TV), it is possible to crop image data for 2D display from the image data after decoding and to obtain 2D image data based on the 2) image region information. Therefore, it is possible to realize service compatibility with respect to a 2D TV when transmitting frame compatible type stereoscopic image data.

In addition, in the stereoscopic television receiving device (3D TV) of the receiving side, it is possible to crop image data for 2D display from the image data after decoding and to obtain 2D image data based on the image region information when a 2D display mode is selected by an operation of the user. Therefore, it is possible to realize service compatibility with respect to a 3D TV (2D display mode) when transmitting frame compatible type stereoscopic image data.

In addition, in the transmission data generation unit 110 shown in FIG. 2, when the compressed video stream is generated and the image data is frame compatible type stereoscopic image data, stereoscopic image information is inserted. Such stereoscopic image region information is image region information for cropping image data for stereoscopic display from the image data after decoding.

Therefore, it is possible to facilitate the process of cropping data in the stereoscopic television receiving device (3DTV) of the receiving side. In other words, in the 3D TV of the receiving side, when a stereoscopic display mode is selected by the operation of a user, it is possible to easily and correctly perform cropping of the image data for stereoscopic display from the image data after decoding based on the stereoscopic image region information, whereby it is possible to favorably obtain left eye image data and right eye image data.

“Configuration Example of 2D Television Receiving Device (2D TV)”

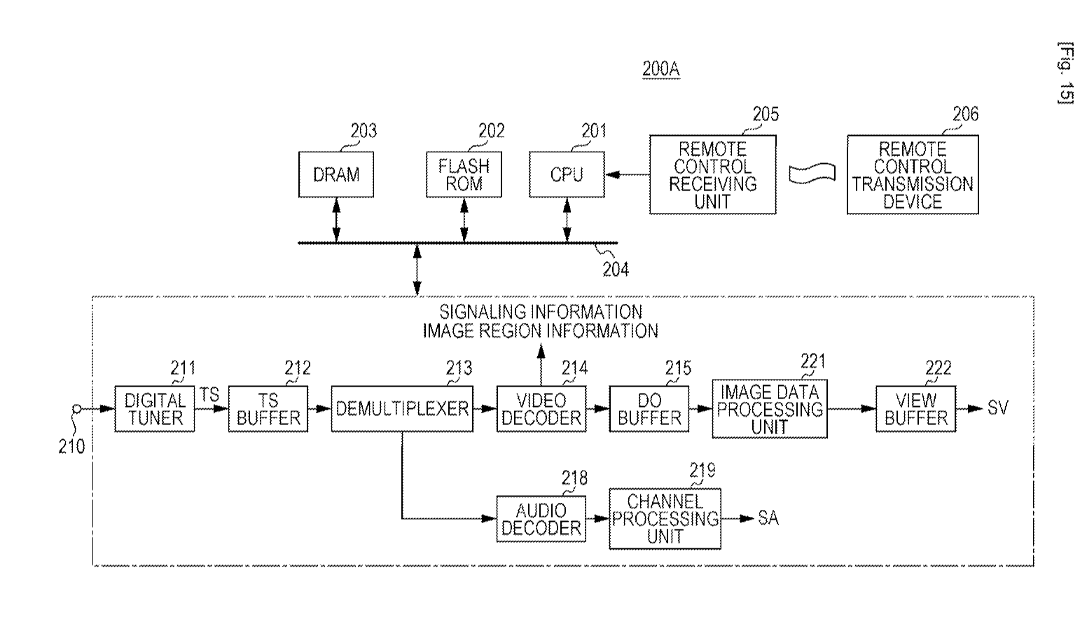

FIG. 15 shows a configuration example of a 2D television receiving device (2D TV) 200A as the receiving device 200. The 2D television receiving device 200A includes a CPU 201, a flash ROM 202, a DRAM 203, an internal bus 204, a remote control receiving unit 205, and a remote control transmission device 206.

Further, the 2D television receiving device 200A includes an antenna terminal 210, a digital tuner 211, a transport stream buffer (TS buffer) 212, and a demultiplexer 213. In addition, the receiving device 200A includes a video decoder 214, a display output buffer (DObuffer) 215, an image data processing unit 216, a view buffer 222, an audio decoder 218, and a channel processing unit 219.

The CPU 201 controls the operation of each portion of the receiving unit 200A. The flash ROM 202 stores the control software and secures data. The DRAM 203 configures a work area of the CPU 201. The CPU 201 develops the software and data read out from the flash ROM 202 on the DRAM 203 and starts the software, thereby controlling each portion of the receiving device 200A. The remote control receiving unit 205 receives the remote control signal transmitted from the remote control transmission device 206 and supplies such to the CPU 201. The CPU 201 controls each portion of the receiving device 200A based on the remote control signal. CPU 201, flash ROM 202, and DRAM 203 are connected to internal bus 204.

The antenna terminal 210 is a terminal for inputting the television broadcast signal received by the receiving antenna (not shown). The digital tuner 211 processes a television broadcast signal input to the antenna terminal 210 and outputs a predetermined transport stream (bit stream data) TS corresponding to the selected channel of a user. The transport stream buffer (TS buffer) 212 temporarily stores the transport stream TS output from the digital tuner 211.

In this embodiment, the transport stream TS is set to be generated by the transmission data generation unit 110 (refer to FIG. 2) of the above-described broadcast station 100. Waiting is performed for the compressed video stream (MPEG2 video stream) of the 2D image data or the stereoscopic image data.

In a compressed video stream of frame compatible type stereoscopic image data, the 2D image region information for cropping the image data for 2D display from the image data after decoding is inserted using the SDE and PDE present in the system layer of the MPEG2 video stream. In addition, in the compressed video stream, stereoscopic image region information for cropping image data for stereoscopic display from the image data after decoding is inserted into the user data region of the picture layer.

The demultiplexer 213 extracts the compressed video stream and the compressed audio stream from the transport stream TS temporarily stored in the TS buffer 212. The video decoder 214 performs a process opposite to the video encoder 112 of the above-described transmission data generation unit 110. That is, the video decoder 214 performs a decoding process with respect to the compressed video stream extracted by the demultiplexer 213 and generates image data. Such imagedata is 2D image data or stereoscopic image data.

As described above, in the transmission data generation unit 110 of the broadcasting station 100, in order to perform the encoding for each 16 by 16 block with respect to stereoscopic image data of 1920 pixels×1088 lines, 8 lines formed of blank data are added and encoding is performed as image data of 1920 pixels×1088 lines. Therefore, the video decoder 214 acquires image data of 1920 pixels and 1088 lines with 8 lines formed of blank data added as the image data after decoding.

In addition, the video decoder 214 reads signaling information of the image data inserted into the picture layer of the compressed video stream. Then, when the image data after decoding is frame compatible type stereoscopic image data, the video decoder 214 extracts the 2D image region information which is for cropping the image data for 2D display from the image data after decoding and which is inserted into the compressed video stream. The video decoder 214 supplies signaling information and 2D image region information to the CPU 201. The video decoder 214 skips over the stereoscopic image region information which is for cropping the image data for stereoscopic display from the image data after decoding and which is inserted into the compressed video stream.

When the image data generated by the video encoder 214 is frame compatible type stereoscopic image data of the side-by-side format, the top-and-bottom format or the like, the CPU 201 recognizes that fact using the signaling information.

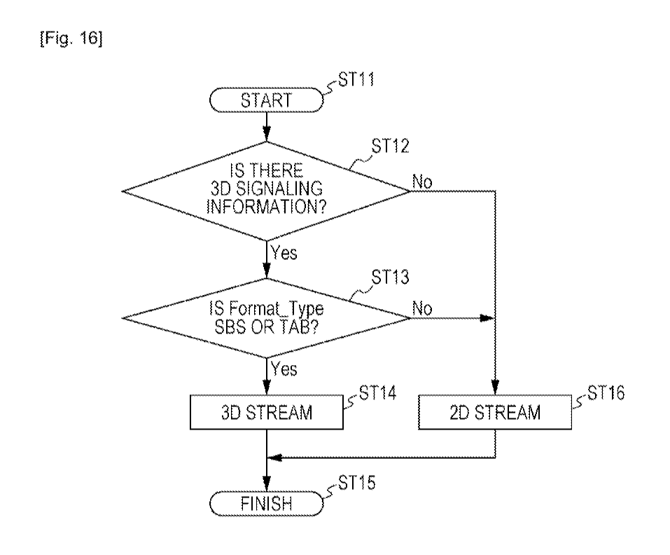

The flowchart of FIG. 16 shows an example of the order of the stream recognition process in the CPU 201. In step ST11, the CPU 201 starts the process, and then moves to the process of step ST12. In step ST12, the CPU 201 determines whether or not it is shown that 3D signaling information is present, that is, that the signaling information is stereoscopic image data.

When there is 3D signaling information, the CPU 201 determines in step ST13 whether or not it is shown that the signaling information is frame compatible type stereoscopic image data with a stereoscopic image data format of side-by-side format, top-and-bottom format, or the like. When the frame compatible type stereoscopic image data is shown, the CPU 201 recognizes in step ST14 that the 3D stream, that is, the image data after decoding is frame compatible type stereoscopic image data, thereafter, in step ST15, the process is finished.

When there is no signaling information in step ST12, or the data is not frame compatible type stereoscopic image data in step ST13, the CPU 201 recognizes a 2D stream, that is, that the image data after decoding is 2D image data in step ST16 and thereafter, in step ST15, the process is finished.

The CPU 201 performs a stream recognition process as described above and, based on the result, controls the process in the image data processing unit 221.

The DO buffer 215 temporarily stores image data acquired by the video decoder 214. The image data processing unit 221 performs a process of cropping image data for 2D display from the image data stored in the DO buffer 215 under the control of the CPU 201, and generates 2D image data SV.

In this case, when the CPU 201 recognizes a 2D stream, that is, that the image data after decoding is 2D image data, the image data processing unit 221 performs a 2D display process which is the same as that conventionally performed and obtains 2D image data SV. Meanwhile, when the CPU 201 recognizes a 3D stream, that is, that the image data after decoding is frame compatible type stereoscopic image data, the image data processing unit 221 generates 2D image data SV using 2D image region information.

That is, when the 2D image region information shows a left eye image data region in the image data after decoding (refer to FIG. 9), the image data processing unit 221 crops the image data of the left eye image data region from the stereoscopic image data after decoding. Then, the image data processing unit 221 performs a horizontal or vertical scaling process with respect to the cropped left eye image data, and obtains 2D image data SV for displaying a 2D image. In this case, the region cut out by the horizontal_size and vertical_size of the Sequence_Display_extension is converted according to the specification of the aspect_ratio_information of the sequence_header.

In addition, when the 2D image region information shows a right eye image data region in the image data after decoding (refer to FIG. 10), the image data processing unit 221 crops the image data of the right eye image data region from the stereoscopic image data after decoding. Then, the image data processing unit 221 performs a horizontal or vertical scaling process with respect to the cropped right eye image data, and obtains 2D image data SV for displaying, a 2D image. In this case as well, the region cut out by the horizontal_size and vertical_size of the Sequence_Display_extension is converted according to the specification of the aspect_ratio_information of the sequence_header.

The view buffer 222 temporarily stores the 2D image data SV obtained by the image data processing unit 221 and then performs output thereof to an image output unit such as a display (not shown).

Brief description will be given of the operation of the two-dimensional television receiving device (2D TV) 200A. The television broadcast signal input to the antenna terminal 210 is supplied to the digital tuner 211. In the digital tuner 211, the television broadcast signal is processed and a predetermined transport stream TS corresponding to the selected channel of a user is output. The transport stream TS is temporarily stored in the TS buffer 212.

The demultiplexer 213 extracts the compressed video stream and the compressed audio stream from the transport stream TS temporarily stored in the TS buffer 212. The compressed video stream is supplied to the video decoder 214, and the compressed audio stream is supplied to the audio decoder 218.

The video decoder 214 performs a decoding process with respect to the compressed video stream extracted by the demultiplexer 213 and generates 2D image data or stereoscopic image data. The image data is temporarily stored in the DO buffer 215.

In addition, in the video decoder 214, the signaling information of the image data inserted into the picture layer of the compressed video stream is read. Then, in the video decoder 214, when the image data after decoding is frame compatible type stereoscopic image data. 2D image region information which is for cropping the image data for 2D display from the image data after decoding and which is inserted into the compressed video stream is extracted. The signaling information and the 2D image region information are supplied to the CPU 201.

The CPU 201 determines whether the stream is a 2D stream or a 3D stream based on the signaling information. Then, based on the result thereof, the process in the image data processing unit 221 is controlled.

When the CPU 2.01 recognizes a 2D stream, that is, that the image data after decoding is 2D image data, the image data processing unit 221 performs a 2D display process which is the same as that conventionally performed and generates 2D image data SV. The 2D image data SV is output to an image output unit such as a display through the view buffer 222. Then, for example, a 2D image is displayed on the display.

Further, when the CPU 201 recognizes a 3D stream, that is, when the image data after decoding is frame compatible type stereoscopic image data, the image data processing unit 221 generates 2D image data SV using 2D image region information.

That is, left eye image data or right eye image data is cropped as image data for 2D display from the stereoscopic image data stored in the DO buffer 215 under the control of the CPU 201. Then in the image data processing unit 221, a horizontal or vertical scaling process is performed with respect to the cropped image data, and 2D image data SV for displaying a 2D image is obtained. The 2D image data SV is output to an image output unit such as a display through the view buffer 222. Then, for example, a 2D image is displayed on the display.

In addition, the compressed audio stream extracted by the demultiplexer 213 is supplied to the audio decoder 218. In this audio decoder 218, a decoding process is performed with respect to the compressed audio stream and decoded audio data is obtained. The audio data is supplied to the channel processing unit 219. The channel processing unit 219 generates audio data SA for each channel in order to realize, for example, 5.1 channel surround sound or the like with respect to the audio data. The audio data SA is output to an audio output unit such as a speaker. Then, for example, audio corresponding to the display image is output from the speaker.

As described above, in the 2D television receiving device (2D TV) 200A shown in FIG. 15, the video decoder 214 extracts 2D image region information which is for cropping the image data for 2D display from the image data after decoding and which is inserted into the compressed video stream using SDE and PDE. Then, in the image data processing unit 221, when the image data after decoding is frame compatible type stereoscopic image data, 2D image region information is used under the control of the CPU 201. In other words, the cropping of the image data for 2D display (left eye image data or right eye image data) from the frame compatible type stereoscopic image data is automatically performed.

Then, in the image data processing unit 221, a horizontal or vertical scaling process is performed with respect to the cropped image data, and 2D image data SV is obtained. Therefore, when frame compatible type stereoscopic image data is to be transmitted, it is possible to automatically display a favorable 2D image without an unnatural image display in which the same images are lined up on the left and right or at the top and bottom.

Above, the video decoder 214 is set to read signaling information of image data inserted into the picture layer of the compressed video stream. Then, when the image data after decoding is frame compatible type stereoscopic image data, the video decoder 214 extracts the 2D image region information inserted into the compressed video stream, and uses this in the 2D display process in the image data processing unit 221.

However, the video decoder 214 may be set to skip both the signaling information of the image data and the stereoscopic image region information inserted into the picture layer of the compressed video stream. Then, the image data processing unit 221 may be set to cutout only one view and perform display thereof using cropping in the SDE (sequence_display_extension) and the PDE (picture_display_extension). This is the same as the case where a 2D display mode is selected by the stereoscopic television receiving device (3D TV), which is described below.

“Configuration Example of Stereoscopic Television Receiving Device (3D TV)”

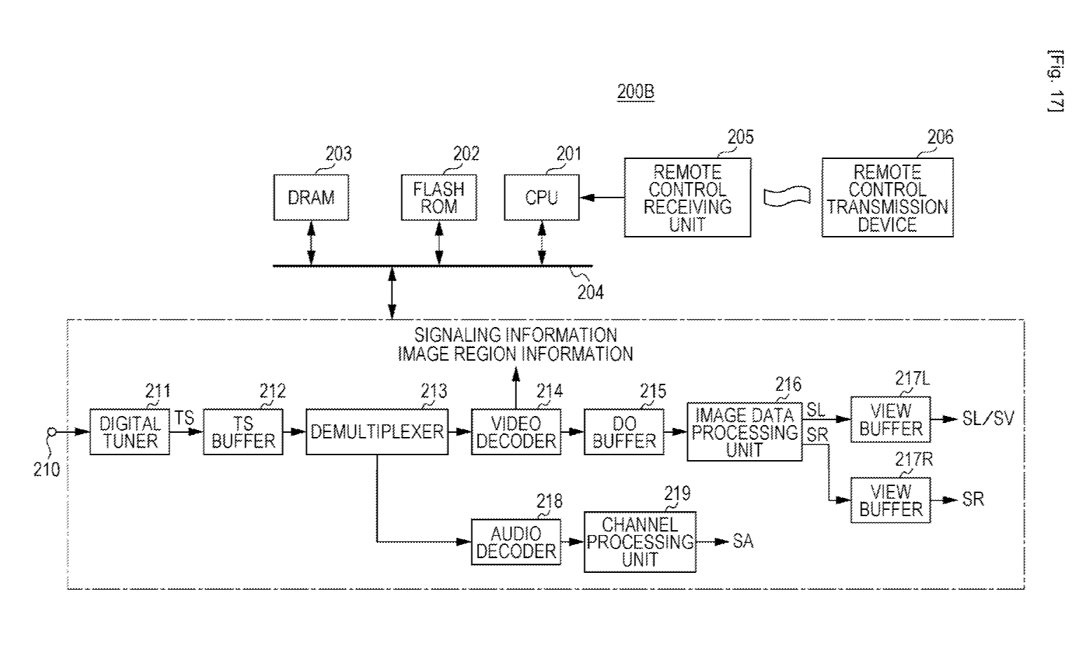

FIG. 17 shows a configuration example of a stereoscopic television receiving device (3D TV) 200B as the receiving device 200. The stereoscopic television receiving device 200B is capable of selecting a 2D display mode or a stereoscopic display mode according to a user operation. The stereoscopic television receiving device 200B displays a stereoscopic image in the stereoscopic display mode and displays a 2D image in the 2D display mode. Further, in FIG. 17, the same reference numerals are applied to the portions corresponding to FIG. 15 and description thereof is omitted as appropriate.

The stereoscopic television receiving device 200B includes a CPU 201, a flash ROM 202, a DRAM 203, an internal bus 204, a remote control receiving unit 205, and a remote control transmission unit 206. Further, the stereoscopic television receiving device 200B includes an antenna terminal 210, a digital tuner 211, a transport streambuffer (TS buffer) 212, and a demultiplexer 213. In addition, the stereoscopic television receiving device 200B includes a video decoder 214, a display output buffer (DO buffer) 215, an image data processing unit 216, view buffers 217L and 217R, an audio decoder 218, and a channel processing unit 219.

As described above, the stereoscopic television receiving device 200B is capable of selecting a 2D display mode or a stereoscopic display mode according to a user operation. The user, for example, is capable of alternatively selecting the 2D display mode or the stereoscopic display mode by operating the remote control transmission device 206. This means that the remote control transmission device 206 is configured as a user operation unit for allowing the user to select the 2D display mode or the stereoscopic display mode.

The video decoder 214 performs a decoding process with respect to the compressed video stream extracted by the demultiplexer 213, and generates 2D image data or stereoscopic image data. This image data is temporarily stored in the DO buffer 215. The image data processing unit 216 generates left eye image data SL and right eye image data SR configuring stereoscopic image data, or 2D image data SV from image data stored in the DO buffer 215 under the control of the CPU 201.

In addition, the video decoder 214 reads signaling information of the image data inserted into the picture layer of the compressed video stream. When the image data after decoding is frame compatible type stereoscopic image data, the video decoder 214 extracts the 2D image region information which is for cropping the image data for 2D display from the image data after decoding and which is inserted into the compressed video stream.

In addition, when the image data after decoding is frame compatible type stereoscopic image data, the video decoder 214 extracts the stereoscopic image region information which is for cropping the image data for stereoscopic display from the image data after decoding and which is inserted into the compressed video stream. The video decoder 214 supplies the signaling information and the image region information (2D image region information, stereoscopic image region information) to the CPU 201.

The CPU 201 determines whether the stream is a 2D stream or a 3D stream based on the signaling information (refer to FIG. 16). Then, based on the result, the CPU 201 controls the process in the image data processing unit 216.

When the CPU 201 recognizes a 2D stream, that is, that the image data after decoding is 2D image data, the image data processing unit 216 performs a 2D display process which is the same as that conventionally performed and generates 2D image data SV.

Further, when the CPU 201 recognizes a 3D stream, that is, that the image data after decoding is frame compatible type stereoscopic image data, the CPU 201 controls the process of the image data processing unit 216 according to the selection state which is one of a 2D display mode or a stereoscopic display mode.

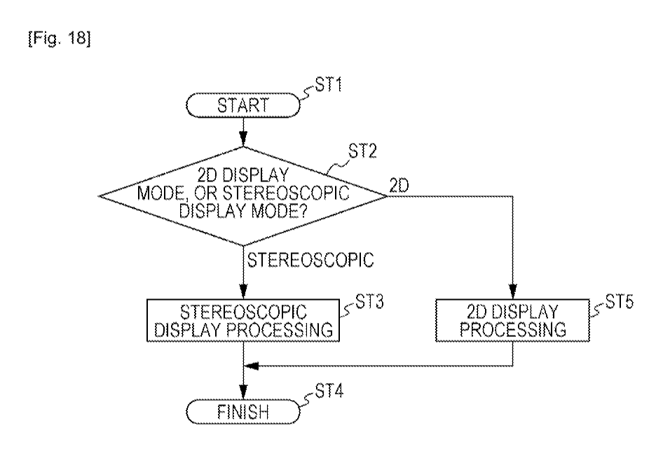

In other words, the CPU 201 switches the process of the image data processing unit 216 based on the above-described display mode selection information according to a user operation. The flowchart of FIG. 18 shows the order of a control process in the CPU 201. The CPU 201 starts the control process in step ST1 and then moves to the process of step ST2. In step ST2, the CPU 201 determines whether the 2D display mode is currently selected or whether the stereoscopic display mode is currently selected.

When the stereoscopic display mode is selected, the CPU 201 switches the process of the image data processing unit 216 to a stereoscopic display process in step ST3, and then finishes the control process in step ST4. On the other hand, when the 2D display mode is selected, the CPU 201 switches the process of the image data processing unit 216 to a 2D display process in step ST5, and then finishes the control processing step ST4.

The CPU 201 performs the control process shown in the flowchart of FIG. 18 periodically, or when a user performs a selection operation of a display mode or the like. Therefore, the image data processing unit 216 performs a stereoscopic display process when the stereoscopic display mode is selected and performs a 2D display process when the 2D display mode is selected.

The stereoscopic display process in the image data processing unit 216 is as follows. That is, the image data processing unit 216 generates left eye image data SL and right eye image data SR using stereoscopic image region information from the stereoscopic image data stored in the DO buffer 215. In other words, the image data processing unit 216 uses the stereoscopic image region information to crop the image data for stereoscopic display from the stereoscopic image data. Then, the image data processing unit 216 divides the cropped image data into two parts of left and right or top and bottom, performs a horizontal direction or vertical direction scaling process on each, and obtains left eye image data SL and right eye image data SR for displaying a stereoscopic image.

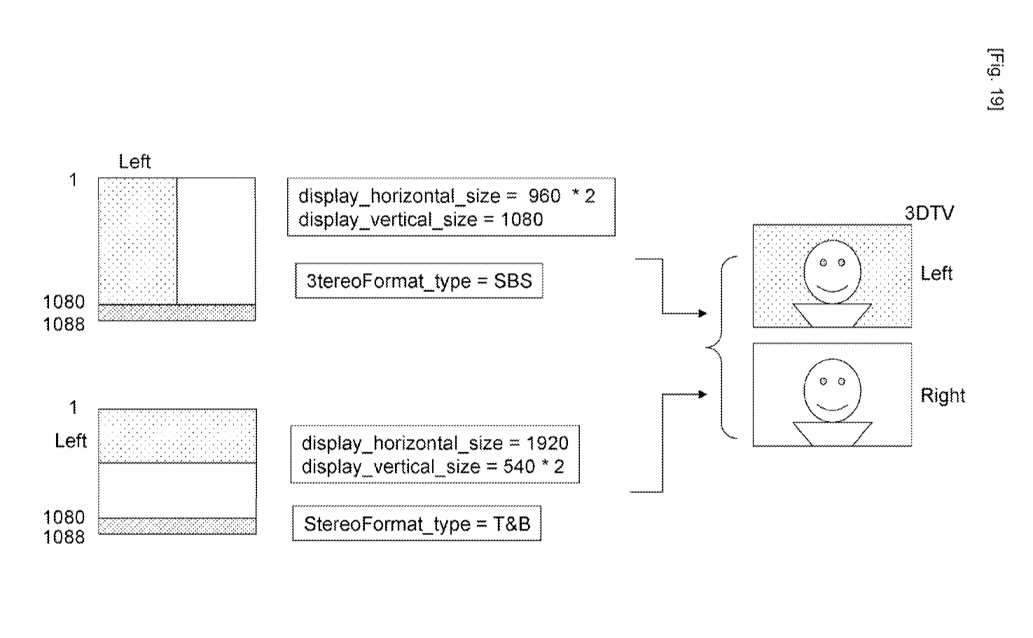

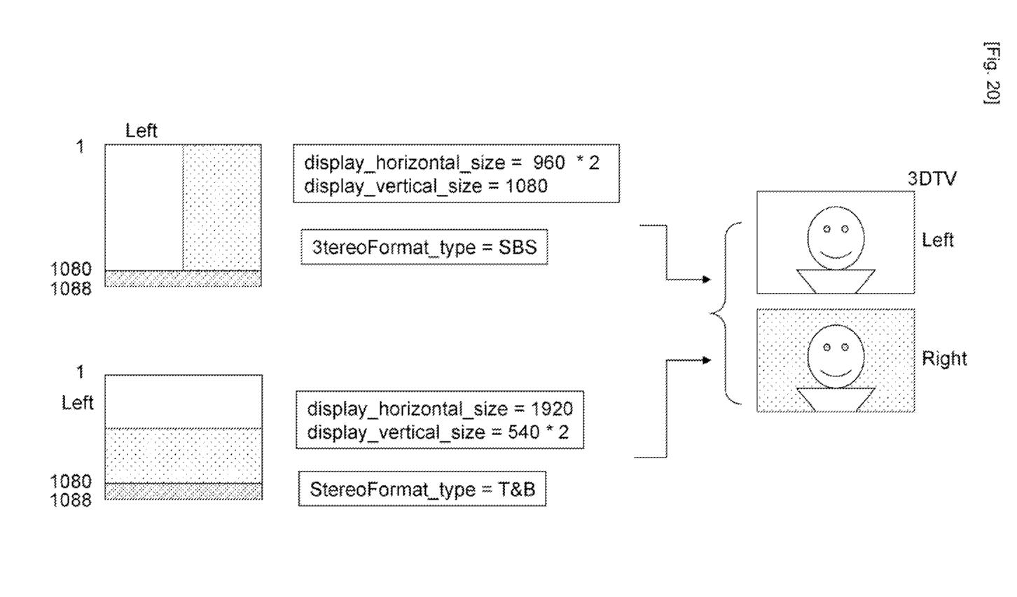

In this case, the image data processing unit 216 is capable of generating left eye image data SL and right eye image data SR using 2D image region information from the stereoscopic image data stored in the DO buffer 215. In this case, as shown in FIG. 19 and FIG. 20, the image data processing unit 216 takes a value double that of the respective display_horizontal_size or display_vertical_size in the image region information, and obtains full resolution left eye image data SL and right eye image data SR from the stereoscopic image data. In other words, a value double that of the half resolution value shown in the image region information is taken, and full resolution left eye image data and right eye image data is obtained.

In addition, the 2D display process in the image data processing unit 216 is as follows. That is, the image data processing unit 216 generates 2D image data SV using 2D image region information. That is, the image data processing unit 216 crops image data (left eye image data and right eye image data) for 2D display based on the above-described 2D image region information from the stereoscopic image data stored in the DO buffer 215 under the control of the CPU 201.

Next, the image data processing unit 216 performs a horizontal or vertical scaling process with respect to the cropped left eye image data, and obtains 2D image data SV (refer to FIG. 9 and FIG. 10). In this case, the region cut out by the horizontal_size and vertical_size of the Sequence_Display_extension is converted according to the specification of the aspect_ratio_information of the sequence_header.

The view buffer 217L temporarily stores the left eye image data SL generated by the image data processing unit 216 or the 2D image data SV and then performs output thereof to an image output unit such as a display (not shown). In addition, the view buffer 217R temporarily stores the right eye image data SR generated by the image data processing unit 216 and then performs output thereof to an image output unit such as a display (not shown).

Although detailed description is omitted, other than the stereoscopic television receiving device 200B shown in FIG. 17, the configuration is the same as the 2D television receiving device 200A shown in the above FIG. 15.

Brief description will be given of the operation of the stereoscopic television receiving device 200B. The television broadcast signal input to the antenna terminal 210 is supplied to the digital tuner 211. In the digital tuner 211, the television broadcast signal is processed and a predetermined transport stream TS corresponding to the selected channel of a user is output. The transport stream TS is temporarily stored in the TS buffer 212.

The demultiplexer 213 extracts the compressed video stream and the compressed audio stream from the transport stream TS temporarily stored in the TS buffer 212. The compressed video stream is supplied to the video decoder 214, and the compressed audio stream is supplied to the audio decoder 218.

The video decoder 214 performs a decoding process with respect to the compressed video stream extracted by the demultiplexer 213 and generates 2D image data or stereoscopic image data. This stereoscopic image data is temporarily stored in the DO buffer 215.

In addition, in the video decoder 214, the signaling information of the image data inserted into the picture layer of the compressed video stream is read. Then, in the video decoder 214, when the image data after decoding is frame compatible type stereoscopic image data, 2D image region information which is for cropping the image data for 2D display from the image data after decoding and which is inserted into the compressed video stream is extracted.

In addition, when the image data after decoding is frame compatible type stereoscopic image data, the video decoder 214 extracts the stereoscopic image region information which is for cropping the image data for stereoscopic display from the image data after decoding and which is inserted into the compressed video stream. The video decoder 214 supplies the signaling information and the image region information (2D image region information, stereoscopic image region information) to the CPU 201.

The CPU 201 determines whether the stream is a 2D stream or a 3D stream based on the signaling information (refer to FIG. 16). Then, based on the result thereof, the process in the image data processing unit 216 is controlled.

When the CPU 201 recognizes a 2D stream, that is, that the image data after decoding is 2D image data, the image data processing unit 216 performs a 2D display process which is the same as that conventionally performed and generates 2D image data SV. The 2D image data SV is output to an image output unit such as a display through the view buffer 217L. Then, for example, a 2D image is displayed on the display.

When the CPU 201 recognizes a 3D stream, that is, that the image data after decoding is frame compatible type stereoscopic image data, the CPU 201 controls the process in the image data processing unit 216 according to whether the 2D display mode is selected or the stereoscopic display mode is selected. In this case, the process of the image data processing unit 216 is switched by the CPU 201 based on the above-described display mode selection information according to the user operation (refer to FIG. 18). The image data processing unit 216 performs a stereoscopic display process when the stereoscopic display mode is selected and performs a 2D display process when the 2D display mode is selected.

In addition, the stereoscopic display process in the image data processing unit 216 is as follows. That is, the image data processing unit 216 crops image data for stereoscopic display using stereoscopic image region information from the stereoscopic image data stored in the DO buffer 215. Then, in the image data processing unit 216, the cropped image data is divided into two parts of left and right or top and bottom, a horizontal direction or vertical direction scaling process is performed on each, and left eye image data SL and right eye image data SR for displaying a stereoscopic image are obtained.

The image data SL and SR are output to an image output unit such as a display through the view buffers 217L and 217R. Image display is performed on the display so that the user perceives a stereoscopic image. For example, with the shutter glasses method, a left eye image and a right eye image are alternately displayed in synchronization with the shutter operation of the shutter glasses.

In addition, in the image data processing unit 216, the following processing is performed as the 2D display processing. That is, in the image data processing unit 216, left eye image data or right eye image data is cropped as image data for 2D display from the stereoscopic image data stored in the DO buffer 215 using the 2D image region information. Then, in the image data processing unit 216, a horizontal or vertical scaling process is performed with respect to the cropped image data, and 2D image data SV is obtained. The dimension image data SV is output to an image output unit such as a display through the view buffer 217L. Then, for example, a 2D image is displayed on the display.

As described above, in the stereoscopic television receiving device (3D TV) 200B shown in FIG. 17, when the image data after decoding is frame compatible type stereoscopic image data, the video decoder 214 extracts 2D image region information. In other words, in the video decoder 214, when the image data after decoding is frame compatible type stereoscopic image data, 2D image region information which is for cropping the image data for 2D display from the image data after decoding and which is inserted into the above-described compressed video stream using SDE and PDE is extracted.

Then, in the image data processing unit 216, when the image data after decoding is frame compatible type stereoscopic image data, 2D image region information is used under the control of the CPU 201 when the 2D display mode is selected. In other words, the cropping of the image data for 2D display (left eye image data or right eye image data) from the frame compatible type stereoscopic image data is automatically performed using the 2D image region information.

Then, in the image data processing unit 216, a horizontal or vertical scaling process is performed with respect to the cropped image data, and 2D image data SV is obtained. Therefore, when frame compatible type stereoscopic image data is to be transmitted, it is possible to automatically display a favorable 2D image without an unnatural image display in which the same images are lined tip on the left and right or at the top and bottom.

in addition, in the stereoscopic television receiving device (3D TV) 200B shown in FIG. 17, when the image data after decoding is frame compatible type stereoscopic image data, the video decoder 214 extracts stereoscopic image region information. In other words, the video decoder 214 extracts the stereoscopic image region information which is for cropping the image data for stereoscopic display from the image data after decoding and which is inserted into user data region of the picture layer of the compressed video stream as described above.

Then, in the image data processing unit 216, when the image data after decoding is frame compatible type stereoscopic image data, the stereoscopic image region information is used under the control of the CPU 201 when the stereoscopic display mode is selected. In other words, using the stereoscopic image region information, the cropping of the image data for stereoscopic display from the frame compatible type stereoscopic image data is automatically performed. Therefore, it is possible to easily and correctly perform cropping of the image data for stereoscopic display from the image data after decoding, whereby it is possible to favorably obtain left eye image data SL and right eye image data SR.

### 2. Modification

Here, in the above-described embodiments, an example was given in which both information showing the size of a region and information showing the position of a region are inserted into a compressed video stream (MPEG2 video stream) as 2D image region information. However, inserting only the information showing the size of the region into the compressed video stream as the 2D image region information may be considered.

In such a case, with the side by side method, in the receiving side, for example, image data in the left side region or the right side region is set to be mechanically cropped as image data for 2D display. Further, in such a case, with the top and bottom method, in the receiving side, for example, image data in the top side region or the bottom side region is set to be cropped as image data for 2D display.

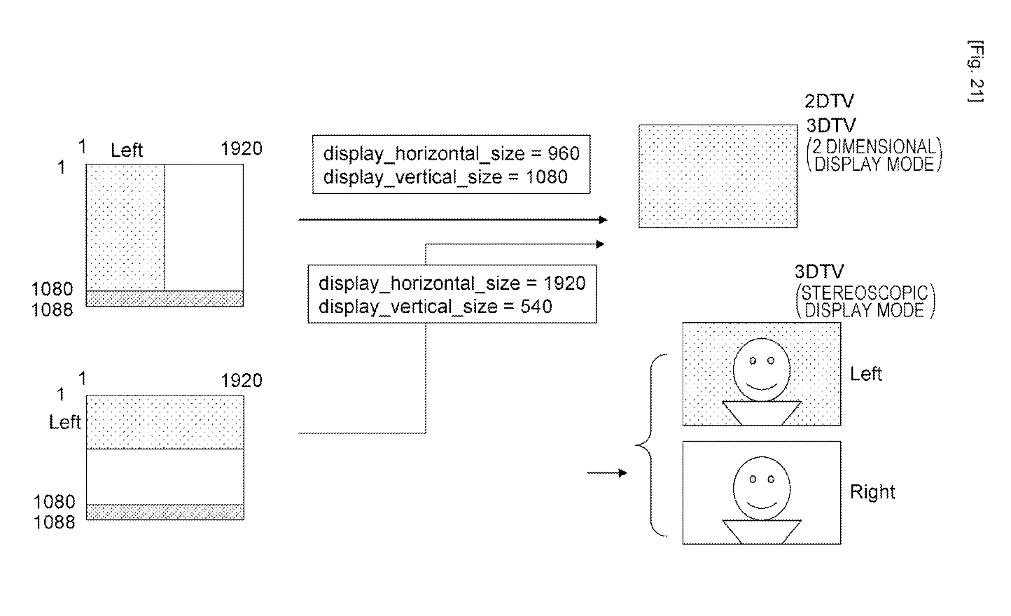

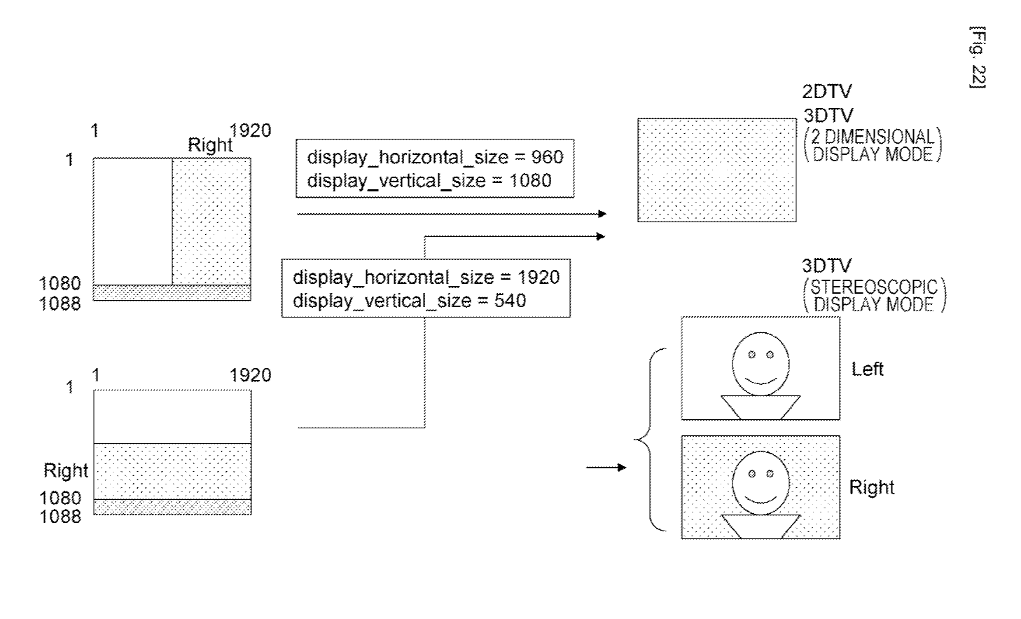

In such a case, for example, only the SDE present in the system layer of the MPEG2 video stream is used, and as the image region information, only information showing the size of the region is inserted. FIG. 21 and FIG. 22 show examples of setting extended parameters in the SDE in such a case. FIG. 21 shows an example of a case of cropping left eye image data present in the left side in the side by side method and left eye image data present in the top side in the top and bottom method in the receiving side. In addition, FIG. 22 shows an example of a case of cropping right eye image data present in the right side in the side by side method and right eye image data present in the bottom side in the top and bottom method in the receiving side.

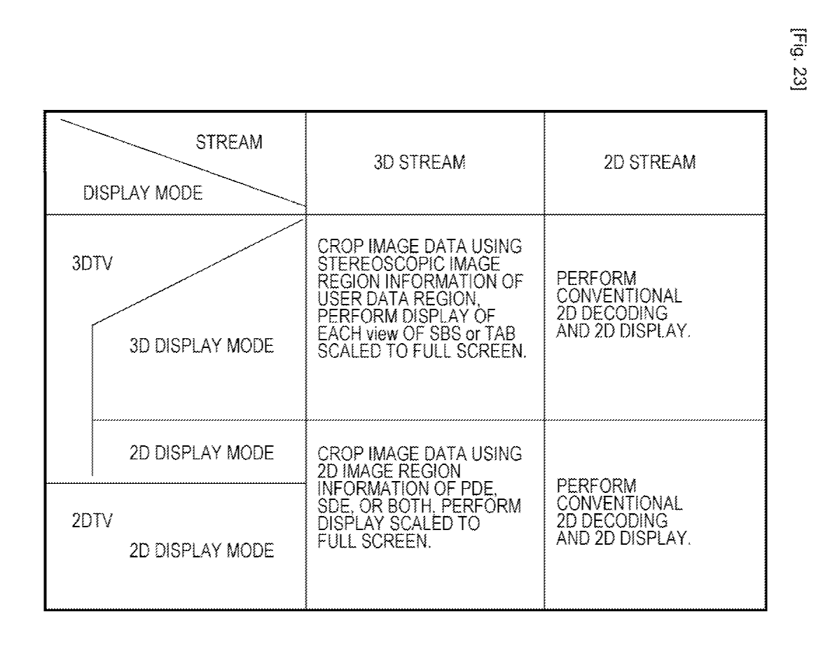

FIG. 23 shows a summary of the display processes with respect to the 2D stream and the 3D stream in the above-described 2D television receiving device (2D TV) 200A and the stereoscopic television receiving device (3D TV) 200B.

In addition, in the above-described embodiments, an example in which 2D image region information is inserted using the SDE and PDE present in the system layer of the compressed video stream (MPEG2 video stream) is shown. However, the arrangement position of the 2D image region information in the compressed video stream is not limited to the SDE and PDE and may be arranged at other positions.

Further, in the above-described embodiments, an example in which 2D image region information is formed of information showing the size of the cropping region (rectangular region) and information showing the position of the cropping region is shown. Although horizontal and vertical size information is set as the information showing the size of the cropping region, for example, it is also possible to set pattern numbers or the like showing a plurality of region patterns for which the horizontal and vertical sizes are different. Similarly, as information showing the position of the cropped region, an offset value of the center position of the cropped region from the center position of the image data after decoding is set however, in a case where only one of the left eye image data and the right eye image data is cropped, for example, the information may be information identifying “left” or “right” (“top” or “bottom”).

In addition, in the embodiment described above, an example in which the compressed video stream is an MPEG2 video stream is shown; however, the present technique may be applied in a case of transmitting a compressed video stream of another format.

In addition, in the embodiment described above, both the 2D image region information and the stereoscopic image region information are inserted into the compressed video stream. However, a configuration in which only one is inserted may be considered.

In addition, the present technology may also be configured as follows.

(1) An image data transmission apparatus including: an encoding unit performing an encoding process with respect to image data and generating a compressed video stream; and a transmission unit transmitting the compressed video stream generated by the encoding unit, in which the encoding unit inserts image region information for cropping image data for 2D display from image data after decoding into the compressed video stream when the image data is frame compatible type stereoscopic image data.

(2) The image data transmission apparatus according to (1) in which the image region information is information showing the size of the region and information showing the position of the region, or information showing the size of the region.

(3) The image data transmission apparatus according to (1) or (2) in which the compressed video stream is an MPEG2 video format compressed video stream, the information showing the size of the region is included as an extension parameter in the Sequence Display Extension, and the information showing the position of the region is included as an extension parameter in the Picture Display Extension.

(4) The image data transmission apparatus according to any one of (1) to (3) in which the frame compatible type stereoscopic image data is side-by-side format or top-and-bottom format stereoscopic image data.

(5) The image data transmission apparatus according to any one of (1) to (4) in which, when the image data is frame compatible type stereoscopic image data, the encoding unit further inserts image region information for cropping the image data for stereoscopic display from the image data after decoding into the compressed video stream.

(6) An image data transmission method including: an encoding step of performing an encoding process with respect to the image data and generating a compressed video stream; and a transmission step of transmitting the compressed video stream generated in the encoding step, in which, in the encoding step, when the image data is frame compatible type stereoscopic image data, image region information for cropping image data for 2D display from the image data after decoding is inserted into the compressed video stream.

(7) An image data receiving apparatus including: a receiving unit receiving a compressed video stream generated by performing an encoding process with respect to image data; a decoding unit performing a decoding process with respect to the compressed video stream received in the receiving unit and generating image data; and an image data processing unit obtaining image data for display based on the image data generated in the decoding unit, in which image region information for cropping image data for 2D display from the image data after decoding is inserted into the compressed video stream when the image data is frame compatible type stereoscopic image data, and the image data processing unit uses the image region information inserted into the compressed video stream from the stereoscopic image data, crops image data for 2D display, and obtains 2D image data when the image data generated in the decoding unit is frame compatible type stereoscopic image data.

(8) The image data receiving apparatus according to (7) further including a user operation unit by which a user selects a 2D display mode or a stereoscopic display mode, in which, in a case where the 2D display mode is selected by the user operation unit when the image data generated in the decoding unit is frame compatible type stereoscopic image data, the image data processing unit uses the image region information inserted in the compressed video stream, crops image data for 2D display from the stereoscopic image data, and obtains 2D image data.

(9) The image data receiving apparatus according to (7) or (8) further including a user operation unit by which a user selects a 2D display mode or a stereoscopic display mode, in which, in a case where the stereoscopic display mode is selected by the user operation unit when the image data generated in the decoding unit is frame compatible type stereoscopic image data, the image data processing unit takes a value double that of the half resolution value shown in the image region information inserted in the compressed video stream, and obtains full resolution left eye image data and right eye image data from the stereoscopic image data.

(10) An image receiving method including: a receiving step of receiving a compressed video stream generated by performing an encoding process with respect to image data; a decoding step of performing a decoding process with respect to the compressed video stream received in the receiving step and generating image data; and an image data processing step of obtaining image data for display based on the image data generated in the decoding step, in which image region information for cropping image data for 2D display from the image data after decoding is inserted into the compressed video stream when the image data is frame compatible type stereoscopic image data, and, in the image data processing step, the image region information inserted into the compressed video stream from the stereoscopic image data is used, image data for 2D display is cropped, and 2D image data is obtained when the image data generated in the decoding step is frame compatible type stereoscopic image data.

(11) An image data transmission apparatus including: an encoding unit performing an encoding process with respect to image data and generating a compressed video stream; and a transmission unit transmitting the compressed video stream generated in the encoding unit, in which the encoding unit inserts image region information for cropping image data for stereoscopic display from the image data after decoding into the compressed video stream when the image data is frame compatible type stereoscopic image data.

(12) The image data transmission apparatus according to (11) in which the compressed video stream is an MPEG2 video format compressed video stream, and the image region information is inserted into the user data region of the picture layer.

(13) The image data transmission apparatus according to (12) in which signaling information capable of identifying frame compatible type stereoscopic image data is inserted into the user data region of the picture layer and the image region information is inserted at a position after the signaling information.

(14) The image data transmission apparatus according to any one of (11) to (13) in which the frame compatible type stereoscopic image data is side-by-side format or top-and-bottom format stereoscopic image data.

(15) An image data transmission method including: an encoding step of performing an encoding process with respect to the image data and generating a compressed video stream; and a transmission step of transmitting the compressed video stream generated in the encoding step, in which, in the encoding step, when the image data is frame compatible type stereoscopic image data, image region information for cropping image data for stereoscopic display from the image data after decoding is inserted into the compressed video stream.

(16) An image data receiving apparatus including: a receiving unit receiving a compressed video stream generated by performing an encoding process with respect to image data; a decoding unit performing a decoding process with respect to the compressed video stream received in the receiving unit and generating image data; and an image data processing unit obtaining image data for display based on the image data generated in the decoding unit, in which image region information for cropping image data for stereoscopic display from the image data after decoding is inserted into the compressed video stream when the image data is frame compatible type stereoscopic image data, and the image data processing unit uses the image region information inserted into the compressed video stream from the stereoscopic image data, crops image data for stereoscopic display, and obtains left eye image data and right eye image data when the image data generated in the decoding unit is frame compatible type stereoscopic image data.

(17) The image data receiving apparatus according to (16) further including a user operation unit by which a user selects a 2D display mode or a stereoscopic display mode, in which, in a case where the stereoscopic display mode is selected by the user operation unit when the image data generated in the decoding unit is frame compatible type stereoscopic image data, the image data processing unit uses the image region information inserted in the compressed video stream, crops image data for stereoscopic display from the stereoscopic image data, and obtains left eye image data and right eye image data.

(18) An image receiving method including: a receiving step of receiving a compressed video stream generated by performing an encoding process with respect to image data; a decoding step of performing a decoding process with respect to the compressed video stream received in the receiving step and generating image data; and an image data processing step of obtaining image data for display based on the image data generated in the decoding step, in which image region information for cropping image data for stereoscopic display from the image data after decoding is inserted into the compressed video stream when the image data is frame compatible type stereoscopic image data, and, in the image data processing step, the image region information inserted into the compressed video stream from the stereoscopic image data is used, image data for stereoscopic display is cropped, and left eye image data and right eye image data are obtained when the image data generated in the decoding step is frame compatible type stereoscopic image data.

(19) An image data receiving apparatus including: a receiving unit receiving a compressed video stream generated by performing an encoding process with respect to image data; a decoding unit performing a decoding process with respect to the compressed video stream received in the receiving unit and generating image data; and an image data processing unit obtaining image data for display based on the image data generated in the decoding unit, in which first image region information for cropping image data for 2D display from the image data after decoding and second image region information for cropping image data for stereoscopic display from the image data after decoding are inserted into the compressed video stream when the image data is frame compatible type stereoscopic image data, the image data receiving apparatus further including a user operation unit by which a user selects a 2D display mode or a stereoscopic display mode, in which, in a case where the 2D display mode is selected by the user operation unit when the image data generated in the decoding unit is frame compatible type stereoscopic image data, the image data processing unit uses the first image region information inserted in the compressed video stream, crops image data for 2D display from the stereoscopic image data, and obtains 2D image data, and in a case where the stereoscopic display mode is selected by the user operation unit, the image data processing unit uses the second image region information inserted in the compressed video stream, crops image data for stereoscopic display from the stereoscopic image data, and obtains left eye image data and right eye image data.

### REFERENCE SIGNS LIST

10 IMAGE TRANSCEIVER SYSTEM
100 BROADCAST STATION
110 TRANSMISSION DATA GENERATION UNIT
111 DATA EXTRACTION UNIT
111a DATA RECORDING MEDIUM
112 VIDEO ENCODER
113 AUDIO ENCODER
114 MULTIPLEXER
200 RECEIVING DEVICE
200A 2D TELEVISION RECEIVING DEVICE (2D TV)
200B STEREOSCOPIC TELEVISION RECEIVING DEVICE (3D TV)
201 CPU
206 REMOTE CONTROL TRANSMISSION DEVICE
210 ANTENNA TERMINAL
211 DIGITAL TUNER
212 TRANSPORT STREAM BUFFER (TSBUFFER)
213 DEMULTIPLEXER
214 VIDEO DECODER
215 DISPLAY OUTPUT BUFFER (DO BUFFER)
216 IMAGE DATA PROCESSING UN IT
217L, 217R VIEW BUFFER
218 AUDIO DECODER
219 CHANNEL PROCESSING UNIT
221 IMAGE DATA PROCESSING UNIT
222 VIEW BUFFER

1. An image data transmission apparatus comprising:
an encoding unit performing an encoding process with respect to image data and generating a compressed video stream; and
a transmission unit transmitting the compressed video stream generated by the encoding unit,
wherein the encoding unit inserts image region information for cropping image data for 2D display from image data after decoding into the compressed video stream when the image data is frame compatible type stereoscopic image data.

2. The image data transmission apparatus according to claim 1, wherein the image region information is information showing the size of the region and information showing the position of the region, or information showing the size of the region.

3. The image data transmission apparatus according to Claim 2, wherein the compressed video stream is an MPEG2 video format compressed video stream,
the information showing the size of the region is included as an extension parameter in the Sequence Display Extension, and
the information showing the position of the region is included as an extension parameter in the Picture Display Extension.

4. The image data transmission apparatus according to Claim 1, wherein the frame compatible type stereoscopic image data is side-by-side format or top-and-bottom format stereoscopic image data.

5. The image data transmission apparatus according to Claim 1, wherein, when the image data is frame compatible type stereoscopic image data, the encoding unit further inserts image region information for cropping the image data for stereoscopic display from the image data after decoding into the compressed video stream.

6. An image data transmission method comprising:
an encoding of step of performing an encoding process with respect to the image data and generating a compressed video stream; and
a transmission step of transmitting the compressed video stream generated in the encoding step,
wherein, in the encoding step, when the image data is frame compatible type stereoscopic image data, image region information for cropping image data for 2D display from the image data after decoding is inserted into the compressed video stream.

7. An image data receiving apparatus comprising:
a receiving unit receiving a compressed video stream generated by performing an encoding process with respect to image data;
a decoding unit performing a decoding process with respect to the compressed video stream received in the receiving unit and generating image data; and
an image data processing unit obtaining image data for display based on the image data generated in the decoding unit,
wherein image region information for cropping image data for 2D display from the image data after decoding is inserted into the compressed video stream when the image data is frame compatible type stereoscopic image data, and
the image data processing unit uses the image region information inserted into the compressed video stream from the stereoscopic image data, crops image data for 2D display, and obtains 2D image data when the image data generated in the decoding unit is frame compatible type stereoscopic image data.

8. The image data receiving apparatus according to Claim 7 further comprising:
a user operation unit by which a user selects a 2D display mode or a stereoscopic display mode,
wherein, in a case where the 2D display mode is selected by the user operation unit when the image data generated in the decoding unit is frame compatible type stereoscopic image data, the image data processing unit uses the image region information inserted in the compressed video stream, crops image data, for 2D display from the stereoscopic image data, and obtains 2D image data.

9. The image data receiving apparatus according to Claim 7 further comprising:
a user operation unit by which a user selects a 2D display mode or a stereoscopic display mode,
wherein, in a case where the stereoscopic display mode is selected by the user operation unit when the image data generated in the decoding unit is frame compatible type stereoscopic image data, the image data processing unit takes a value double that of the half resolution value shown in the image region information inserted in the compressed video stream, and obtains full resolution left eye image data and right eye image data from the stereoscopic image data.

10. An image receiving method comprising:
a receiving step of receiving a compressed video stream generated by performing an encoding process with respect to image data;
a decoding step of performing a decoding process with respect to the compressed video stream received in the receiving step and generating image data; and
an image data processing step of obtaining image data for display based on the image data generated in the decoding step,
wherein image region information for cropping image data for 2D display from the image data after decoding is inserted into the compressed video stream when the image data is frame compatible type stereoscopic image data, and,
in the image data processing step, the image region information inserted into the compressed video stream from the stereoscopic image data is used, image data for 2D display is cropped, and 2D image data is obtained when the image data generated in the decoding step is frame compatible type stereoscopic image data.

11. An image data transmission apparatus comprising:
an encoding unit performing an encoding process with respect to image data and generating a compressed video stream; and
a transmission unit transmitting the compressed video stream generated in the encoding unit,
wherein the encoding unit inserts image region information for cropping image data for stereoscopic display from the image data after decoding into the compressed video stream when the image data is frame compatible type stereoscopic image data.

12. The image data transmission apparatus according to Claim 11, wherein the compressed video stream is an MPEG2 video format compressed video stream, and
the image region information is inserted into the user data region of a picture layer.

13. The image data transmission apparatus according to Claim 12, wherein signaling information capable of identifying frame compatible type stereoscopic image data is inserted into the user data region of the picture layer and
the image region information is inserted at a position after the signaling information.

14. The image data transmission apparatus according to Claim 11, wherein the frame compatible type stereoscopic image data is side-by-side format or top-and-bottom format stereoscopic image data.

15. An image data transmission method comprising:
an encoding step of performing an encoding process with respect to the image data and generating a compressed video stream; and
a transmission step of transmitting the compressed video stream generated in the encoding step,
wherein, in the encoding step, when the image data is frame compatible type stereoscopic image data, image region information for cropping image data for stereoscopic display from the image data after decoding is inserted into the compressed video stream.

16. An image data receiving apparatus comprising:
a receiving unit receiving a compressed video stream generated by performing an encoding process with respect to image data;
a decoding unit performing a decoding process with respect to the compressed video stream received in the receiving unit and generating image data; and
an image data processing unit obtaining image data for display based on the image data generated in the decoding unit,
wherein image region information for cropping image data for stereoscopic display from the image data after decoding is inserted into the compressed video stream when the image data is frame compatible type stereoscopic image data, and
the image data processing unit uses the image region information inserted into the compressed video stream from the stereoscopic image data, crops image data for stereoscopic display, and obtains left eye image data and right eye image data when the image data generated in the decoding unit is frame compatible type stereoscopic image data.

17. The image data receiving apparatus according to Claim 16 further comprising:
a user operation unit by which a user selects a 2D display mode or a stereoscopic display mode,
wherein, in a case where the stereoscopic display mode is selected by the user operation unit when the image data generated in the decoding unit is frame compatible type stereoscopic image data, the image data processing unit uses the image region information inserted in the compressed video stream, crops image data for stereoscopic display from the stereoscopic image data, and obtains left eye image data and right eye image data.

18. An image receiving method comprising:
a receiving step of receiving a compressed video stream generated by performing an encoding process with respect to image data;
a decoding step of performing a decoding process with respect to the compressed video stream received in the receiving step and generating image data; and
an image data processing step of obtaining image data for display based on the image data generated in the decoding step,
wherein image region information for cropping image data for stereoscopic display from the image data after decoding is inserted into the compressed video stream when the image data is frame compatible type stereoscopic image data, and,
in the image data processing step, the image region information inserted into the compressed video stream from the stereoscopic image data is used, image data for stereoscopic display is cropped, and left eye image data and right eye image data are obtained when the image data generated in the decoding step is frame compatible type stereoscopic image data.

19. An image data receiving apparatus comprising:
a receiving unit receiving a compressed video stream generated by performing an encoding process with respect to image data;
a decoding unit performing a decoding process with respect to the compressed video stream received in the receiving unit and generating image data; and
an image data processing unit obtaining image data for display based on the image data generated in the decoding unit,
wherein first image region information for cropping image data for 2D display from the image data after decoding and second image region information for cropping image data for stereoscopic display from the image data after decoding are inserted into the compressed video stream when the image data is frame compatible type stereoscopic image data,
the image data receiving apparatus further comprises a user operation unit by which a user selects a 2D display mode or a stereoscopic display mode,
in a case where the 2D display mode is selected by the user operation unit when the image data generated in the decoding unit is frame compatible type stereoscopic image data, the image data processing unit uses the first image region information inserted in the compressed video stream, crops image data for 2D display from the stereoscopic image data, and obtains 2D image data, and
in a case where the stereoscopic display mode is selected by the user operation unit, the image data processing unit uses the second image region information inserted in the compressed video stream, crops image data for stereoscopic display from the stereoscopic image data, and obtains left eye image data and right eye image data.
